(19) United States
(12) Patent Application Publication
(10) Pub. No.: US 2020/0148590 A1
(43) Pub. Date: May 14, 2020

(54) GLASS SUBSTRATES WITH IMPROVED COMPOSITIONS

(71) Applicant: CORNING INCORPORATED, CORNING, NY (US)

(72) Inventor: Vitor Marino Schneider, Painted Post, NY (US)

(21) Appl. No.: 16/677,968

(22) Filed: Nov. 8, 2019

Related U.S. Application Data
(60) Provisional application No. 62/767,200, filed on Nov. 14, 2018.

(51) Int. Cl. C03C 21/00; C03C 4/18; C03C 3/097

(52) U.S. Cl. CPC C03C 21/002; C03C 2204/00; C03C 3/097; C03C 4/18

(57) ABSTRACT

Methods of making glass substrates comprise: obtaining a base glass from a bulk process; exposing the base glass to a first ion exchange treatment including ions of a first metal to form a protected base glass; exposing the protected base glass to a second ion exchange treatment including the ions of the first metal and ions of a second metal to form a modified base glass; and annealing the modified base glass to remove substantially all stress and to obtain a distributed concentration profile of the alkali metal oxide, an oxide of the first metal, and an oxide of the second metal, thereby forming the glass substrate.

This application claims the benefit of priority under 35 U.S.C. § 119 of U.S. Provisional Application Ser. No. 62/767,200 filed on Nov. 14, 2018, the content of which is relied upon and incorporated herein by reference in its entirety.

### FIELD

Embodiments of the disclosure generally relate to methods of making glass substrates that have improved compositions. In particular, the glass substrates are derived from base glasses that are readily manufactured in bulk processes and thereafter processed to arrive at new compositions that are amenable to strengthening.

### BACKGROUND

Glass-based articles are used in many various industries including consumer electronics, transportation, architecture, defense, medical, and packaging. For consumer electronics, glass-based articles are used in electronic devices as cover plates or windows for portable or mobile electronic communication and entertainment devices, such as mobile phones, smart phones, tablets, video players, information terminal (IT) devices, laptop computers, navigation systems, televisions, and the like. In architecture, glass-based articles are included in windows, shower panels, solar panels, and countertops; and in transportation, glass-based articles are present in automobiles, trains, aircraft, sea craft. Glass-based articles are suitable for any application that requires superior fracture resistance but thin and light-weight articles. For each industry, mechanical and/or chemical reliability of the glass-based articles is typically driven by functionality, performance, and cost. Chemical treatment is a strengthening method to impart a desired/engineered/improved stress profile to a glass substrate. Chemical strengthening by ion exchange (IOX) of an alkali-containing glass substrate is a proven methodology in this field.

Glass-based articles that are flat have become prevalent over the last decade with the appearance of touch screens and several personal electronic devices. Flat glass-based articles are strengthened flat glass substrates. Most flat glass substrates are manufactured based on certain bulk process techniques, including but not limited to, float technique, fusion technique, rolling technique, slot draw technique, or other casting techniques including crucible melting.

Each manufacturing technique has its own set of advantages and disadvantages. Some techniques require further processing in order to arrive at glass substrates that meet desired flatness specifications. The fusion technique typically leads to quasi-atomically flat surfaces that do not require post-polishing of the glass substrate. This feature makes the fusion manufacturing technique economically attractive for the specialty glass used in LCD screens and protective screens due to high the surface quality.

However, the fusion technique has some limitation in terms of the range of viscosities where glass can be formed. The range of viscosities also affects the temperatures of the process and also may lead to possible devitrification of the glass requiring very tight controls. Overall the most visible effect leads to a limitation on the combination of materials that can be added to the glass and made compatible with the fusion draw process. That includes the amount of alkali and alkali-earth based materials that can be used that are of particular interest for glasses used in the strengthening process via ion-exchange.

Strengthening of glass substrates via ion-exchange therefore may be limited to a certain extent by the fusion technique. Glasses with high amount of lithium for example may be more difficult if not impossible to be manufactured by fusion if in conjunction with other glass components leads to low viscosities at its liquidus temperature where the glass can be formed without crystallization.

There is an on-going need to provide glass substrates that are flat and/or amenable receiving enhanced stress profiles to form glass-based articles that are suitable for their particular industry. There is also an ongoing need to do so in cost-effective ways.

### SUMMARY

Aspects of the disclosure pertain to glass substrates and methods for their manufacture and use.

In an aspect, a method of manufacturing a glass substrate comprises: obtaining a base glass having opposing first and second surfaces defining a thickness (t), and comprising a base composition containing an alkali metal oxide; exposing the base glass to a first ion exchange treatment including ions of a first metal to form a protected base glass; exposing the protected base glass to a second ion exchange treatment including the ions of the first metal and ions of a second metal to form a modified base glass; and annealing the modified base glass to reduce stress and to obtain a distributed concentration profile of the alkali metal oxide, an oxide of the first metal, and an oxide of the second metal, thereby forming the glass substrate.

In an aspect, a method of manufacturing a glass substrate comprises: obtaining a base glass having opposing first and second surfaces defining a thickness (t), and comprising a base composition containing an alkali metal oxide; exposing the base glass to a first ion exchange treatment including ions of a first metal to form a protected base glass; exposing the protected base glass to a second ion exchange treatment including the ions of the first metal and ions of a second metal to form a modified base glass; and annealing the modified base glass to reduce residual stress thereby forming the glass substrate; wherein a concentration of an oxide of the second metal in a center of the glass substrate is higher than a concentration of the oxide of the second metal in the base composition.

In an aspect, a method of manufacturing a glass substrate comprises: obtaining a base glass having opposing first and second surfaces defining a substrate thickness (t), and comprising a base composition containing sodium oxide; exposing the base glass that to a first ion exchange treatment including a molten potassium salt to form a protected base glass; exposing the protected base glass to a second ion exchange treatment including the molten potassium salt and a molten lithium salt to form a modified base glass; and annealing the modified base glass to reduce stress and to obtain a distributed concentration profile of the sodium oxide, potassium oxide, and lithium oxide, thereby forming the glass substrate.

In an aspect, a glass-based article comprising: silicon dioxide (SiO₂); aluminum oxide (Al₂O₃); and lithium oxide (Li₂O) in an amount of greater than 11 mol %; and a fusion line.

In an aspect, a glass-based article comprises: opposing first and second surfaces defining a thickness (t); silicon dioxide (SiO₂); aluminum oxide (Al₂O₃); sodium oxide (Na2O); lithium oxide (Li₂O); and potassium oxide (K₂O), wherein a potassium oxide concentration profile of the article comprises a region of decreasing potassium concentration located at a depth of greater than a spike depth of layer and less than or equal to a depth of compression.

In an aspect, a consumer electronic product comprises: a housing having a front surface, a back surface, and side surfaces; electrical components provided at least partially within the housing, the electrical components including at least a controller, a memory, and a display, the display being provided at or adjacent the front surface of the housing; and a cover disposed over the display; wherein a portion of at least one of the housing and the cover comprises a glass-based article of any of embodiment herein.

### BRIEF DESCRIPTION OF THE DRAWINGS

The accompanying figures, which are incorporated in and constitute a part of this specification, illustrate several embodiments described below.

FIG. 1 provides a process flow diagram for a method according to an embodiment;

FIG. 2 is a graph of oxide molar concentration as a function of depth in the glass from a first surface (0 micrometers) after each method step according to Example 1;

FIG. 3 is a graph of oxide molar concentration as a function of depth in the glass from a first surface (0 micrometers) after the last method step (Step III) according to Example 2;

FIG. 4 is a schematic graph of temperature versus time for an annealing process according to an embodiment;

FIG. 5 provides a graph of stress (MPa) versus depth (micrometers) from a surface for Steps I, II, and III for an embodiment;

FIG. 6A is an image of a guided mode spectra fringe for a base glass according to an embodiment;

FIG. 6B is an image of a guided mode spectra fringe for a glass-based article according to an embodiment;

FIG. 7 provides a graph of stress (MPa) versus position (micrometers) from a surface for an embodiment of a glass-based article compared to a base glass;

FIG. 8 provides a graph of stress (MPa) versus position (micrometers) from a surface for an embodiment of a glass-based article;

FIG. 9A provides a graph of oxide molar concentration as a function of depth in the glass from a first surface (0 micrometers) for an embodiment, and FIG. 9B provides an enlargement showing an area of decreasing potassium concentration for an embodiment;

FIG. 10 is a graph of results of a controlled-drop process, where height where cover glass failure occurred is provided for base glasses and embodiments;

FIG. 11 provides a graph of stress (MPa) versus position (micrometers) from a surface for an embodiment of a glass-based article;

FIG. 12A is a plan view of an exemplary electronic device incorporating a glass-based articles formed from any glass substrate disclosed herein;

FIG. 12B is a perspective view of the exemplary electronic device of FIG. 12A; and

FIG. 13 provides a generalized graph of stress and potassium oxide concentration profile versus normalized position.

### DETAILED DESCRIPTION

Before describing several exemplary embodiments, it is to be understood that the disclosure is not limited to the details of construction or process steps set forth in the following disclosure. The disclosure provided herein is capable of other embodiments and of being practiced or being carried out in various ways.

Reference throughout this specification to “one embodiment,” “certain embodiments,” “various embodiments,” “one or more embodiments” or “an embodiment” means that a particular feature, structure, material, or characteristic described in connection with the embodiment is included in at least one embodiment of the disclosure. Thus, the appearances of the phrases such as “in one or more embodiments,” “in certain embodiments,” “in various embodiments,” “in one embodiment” or “in an embodiment” in various places throughout this specification are not necessarily referring to the same embodiment. Furthermore, the particular features, structures, materials, or characteristics may be combined in any suitable manner in one or more embodiments.

### Definitions and Measurement Techniques

The terms “glass-based article”, “glass article”, “glass-based substrates”, and “glass substrates” are used to include any object made wholly or partly of glass. Laminated glass-based articles include laminates of glass and non-glass materials, laminates of glass and crystalline materials.

A “base composition” is a chemical make-up of a substrate prior to any ion exchange (IOX) treatment. That is, the base composition is undoped by any ions from IOX. A composition at the center of a glass-based article that has been IOX treated is typically the same as the base composition when IOX treatment conditions are such that ions supplied for IOX do not diffuse into the center of the substrate. In one or more embodiments, a composition at the center of the glass article comprises the base composition.

A “fusion line” is an optical distortion when a glass is viewed under an optical microscope. The presence of a fusion line is one manner of identifying a fusion drawn glass, which is the result of a glass sheet being formed by the fusion of two glass films.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue. Thus, for example, a glass-based article that is “substantially free of MgO” is one in which MgO is not actively added or batched into the glass-based article, but may be present in very small amounts as a contaminant.

Unless otherwise specified, all compositions described herein are expressed in terms of mole percent (mol %) on an oxide basis.

A “stress profile” is stress with respect to position of a glass-based substrate or article. A compressive stress region extends from a first surface to a depth of compression (DOC) of the article, where the article is under compressive stress. A central tension region extends from the DOC to include the region where the article is under tensile stress.

As used herein, depth of compression (DOC) refers to the depth at which the stress within the glass-based article changes from compressive to tensile stress. At the DOC, the stress crosses from a positive (compressive) stress to a negative (tensile) stress and thus exhibits a stress value of zero. According to the convention normally used in mechanical arts, compression is expressed as a negative (<0) stress and tension is expressed as a positive (>0) stress. Throughout this description, however, compressive stress (CS) is expressed as a positive or absolute value—i.e., as recited herein, CS=|CS|. In addition, tensile stress is expressed herein as a negative (<0) stress. Central tension (CT) refers to tensile stress in a central region or a central tension region of the glass-based article. Maximum central tension (maximum CT or CTₘₐₓ) occurs in the central tension region nominally at 0.5·t, where t is the article thickness, which allows for variation from exact center of the location of the maximum tensile stress.

A “knee” of a stress profile is a depth of an article where the slope of the stress profile transitions from steep to gradual. The knee may refer to a transition area over a span of depths where the slope is changing. The depth of the knee is measured as the depth of layer of the largest ion having a concentration gradient in the article, which is approximately the depth of layer of a spike/steep region (DOLₛₚ). The CS of the knee is the CS at the depth of the knee.

Unless otherwise specified, CT and CS are expressed herein in megaPascals (MPa), thickness is express in millimeters and DOC (depth of compression) and DOL (depth of layer for a particular ion) are expressed in microns (micrometers).

Compressive stress at the surface is measured by surface stress meter (FSM) using commercially available instruments such as the FSM-6000, manufactured by Orihara Industrial Co., Ltd. (Japan). Surface stress measurements rely upon the accurate measurement of the stress optical coefficient (SOC), which is related to the birefringence of the glass. SOC in turn is measured according to Procedure C (Glass Disc Method) described in ASTM standard C770-16, entitled “Standard Test Method for Measurement of Glass Stress-Optical Coefficient,” the contents of which are incorporated herein by reference in their entirety.

The maximum CT value is measured using a scattered light polariscope (SCALP) technique known in the art.

DOC may be measured by FSM or SCALP depending on the ion exchange treatment. Where the stress in the glass article is generated by exchanging potassium ions into the glass article, FSM is used to measure DOC by using a modified inverse-WKB procedure described in U.S. Pat. No. 9,140,543B1 entitled “System and Methods for Measuring the stress profile of ion exchanged glass”. Where the stress is generated by exchanging sodium ions into the glass article, SCALP is used to measure DOC. Where the stress in the glass article is generated by exchanging both potassium and sodium ions into the glass, the DOC is measured by SCALP, since it is believed the exchange depth of sodium indicates the DOC and the exchange depth of potassium ions indicates a change in the magnitude of the compressive stress (but not the change in stress from compressive to tensile); the exchange depth (or DOL) of potassium ions in such glass articles is measured by FSM.

The CS in the remainder of the CS region is measured by the refracted near-field (RNF) method described in U.S. Pat. No. 8,854,623, entitled “Systems and methods for measuring a profile characteristic of a glass sample”, which is hereby incorporated by reference in its entirety. The RNF measurement is force balanced and calibrated to the maximum CT value provided by a SCALP measurement. In particular, the RNF method includes placing the glass-based article adjacent to a reference block, generating a polarization-switched light beam that is switched between orthogonal polarizations at a rate of between 1 Hz and 50 Hz, measuring an amount of power in the polarization-switched light beam and generating a polarization-switched reference signal, wherein the measured amounts of power in each of the orthogonal polarizations are within 50% of each other. The method further includes transmitting the polarization-switched light beam through the glass sample and reference block for different depths into the glass sample, then relaying the transmitted polarization-switched light beam to a signal photodetector using a relay optical system, with the signal photodetector generating a polarization-switched detector signal. The method also includes dividing the detector signal by the reference signal to form a normalized detector signal and determining the profile characteristic of the glass sample from the normalized detector signal.

### Treatment of Base Glasses

Disclosed herein are glass substrates that are amenable to strengthening. Methods herein create unique glass substrates having compositions that are tailored to be further processed by ion exchange and/or thermal strengthening. Starting base glasses are made by any bulk process. In one or more embodiments, the base glass is made by fusion techniques and the methods herein create glass substrates having compositions that are not achievable otherwise by fusion techniques. Starting with base glasses from existing bulk processes is efficient and economical because desired platforms can then be created at a relatively low cost without major engineering or scientific scale-up challenges. In general, methods herein involve the use of multiple ion exchanges to replace alkali present in the base glass by either other alkali, alkali earth elements or some particular metals such as copper, silver or gold, which are able to diffuse inside glasses. The methods also include an annealing step to further diffuse the elements inside the glass and to reduce residual stress in the glass induced by the multiple ion-exchange processes used in the glass modification. In one or more embodiments, the majority, if not all, of the residual stress is removed. The result is a new glass substrate with quasi-uniform content of alkali across its thickness with a different glass composition from the original base glass. This new glass has a different chemical composition and some mechanical properties that can be also tuned. Methods herein are conducted at relatively low and intermediate temperatures of ion exchange and annealing processes (300-700° C.) as compared to traditional glass formation temperatures (900-1300° C.). Certain difficulties presented when using, for example, large amounts of lithium in a base glass, such as achieving reasonable low viscosities during melt and devitrification/crystallization among other issues are circumvented due to the lower temperature of the glass modification.

In an embodiment, a method of manufacturing a glass substrate comprises: obtaining a base glass having opposing first and second surfaces defining a substrate thickness (t), and comprising a base composition containing sodium oxide; exposing the base glass that to a first ion exchange treatment including a molten potassium salt to form a protected base glass; exposing the protected base glass to a second ion exchange treatment including the molten potassium salt and a molten lithium salt to form a modified base glass; and annealing the modified base glass to reduce stress and to obtain a distributed concentration profile of the sodium oxide, potassium oxide, and lithium oxide, thereby forming the glass substrate.

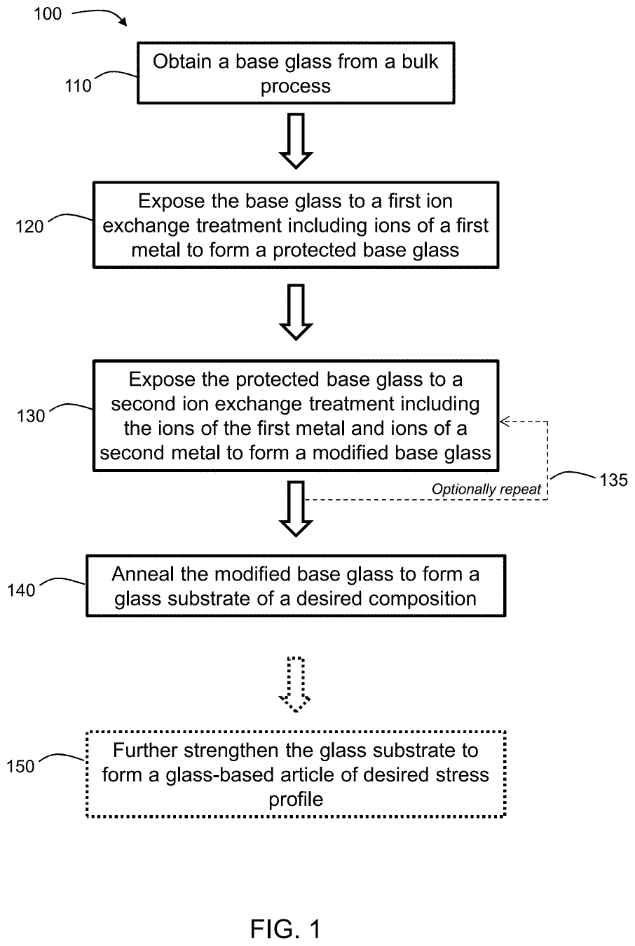

In FIG. 1, a method 100 according to an embodiment starts at 110 by obtaining a base glass from a bulk process. The bulk process includes but is not limited to: float technique, fusion technique, rolling technique, slot draw technique, and crucible melting. The base glass comprises a base composition containing an alkali metal oxide.

At Step I 120, the base glass is exposed to a first ion exchange treatment including ions of a first metal to form a protected base glass. In this first step, an ion exchange of an element, namely the first metal, that is able to induce high stress levels near the immediate surface is chosen. In one or more embodiments, the first metal will be potassium, which induces large stresses when exchanging with sodium and lithium in a glass. Potassium, however, does not diffuse very fast. This means that the potassium will be concentrated mostly in the first 10 to 100 micrometers of the surface of the glass depending on the time and temperature chosen. The first metal will displace some of the alkali metal oxide in this first 10 to 100 micrometers such that concentration of the alkali metal oxide is zero at one or both of the first and second surfaces of the base glass and its concentration varies along a portion of the substrate thickness (t) until the concentration reaches that of the alkali metal oxide in the base composition. An oxide of the first metal will be present in the protected glass in a concentration that is non-zero at one or both of the first and second surfaces and varies along a portion of the substrate thickness (t) until a depth of tₚ where the concentration reaches that of any concentration of the oxide of the first metal in the base composition. Alternatively other heavier ions such as rubidium, cesium and francium could be used but these are more expensive and challenging to process. The intent of this initial ion exchange is to protect the surface of the glass with a high stress and provide some level of stress control to the subsequent steps.

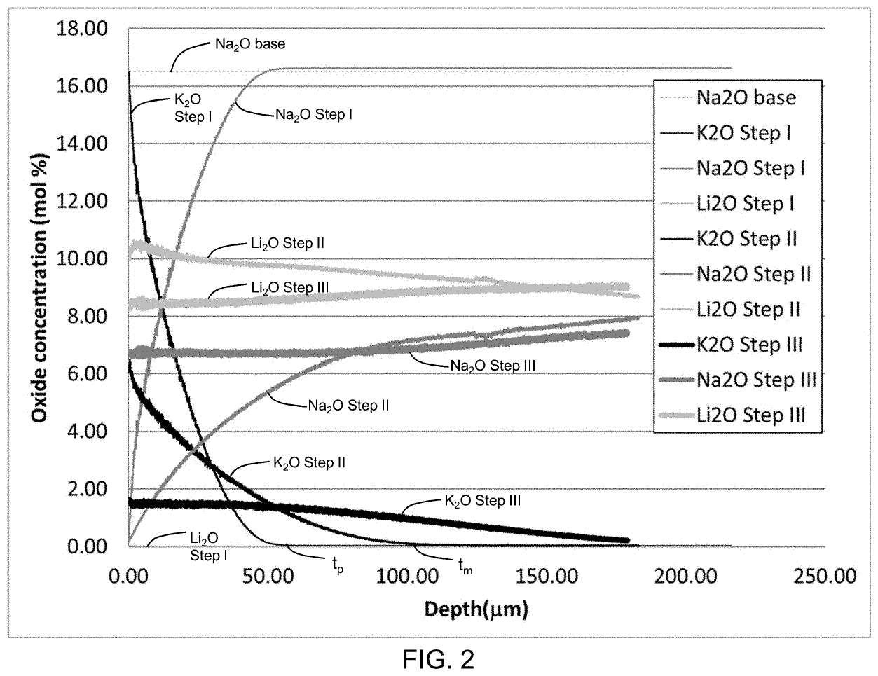

In an embodiment, the alkali metal oxide is present in the protected base glass in a concentration that is zero at one or both of the first and second surfaces and varies along a portion of the substrate thickness (t) until the concentration reaches that of the alkali metal oxide in the base composition; and the oxide of the first metal is present in the protected glass in a concentration that is non-zero at one or both of the first and second surfaces and varies along a portion of the substrate thickness (t) until tₚ where the concentration reaches that of any concentration of the oxide of the first metal in the base composition. By way of the non-limiting example of FIG. 2, which is based on Example 1, the alkali metal oxide is sodium oxide (generally Na₂O), which is present in the base glass in an amount of 16.51 mol % (“Na₂O base” in FIG. 2). After step I, Na₂O shows a concentration of 0 mol % at 0 micrometers (“Na₂O Step I” in FIG. 2), varying until a depth of about 50 micrometers when the Na₂O concentration reaches its concentration in the base composition of 16.51 mol %. In Example 1, potassium was used as the first metal. Concentration of the potassium oxide (generally K₂O) after step I was non-zero at 0 micrometers (“K₂O Step I” in FIG. 2), varying along a portion the substrate thickness (t) until about 50 micrometers (tₚ) where the concentration reached 0 mol %, which was the concentration of the potassium oxide in the base composition.

The presence of the first metal facilitates the ion exchange of Step II.

At Step II 130, the protected base glass is exposed to a second ion exchange treatment including the ions of the first metal and ions of a second metal to form a modified base glass. During Step II, the basis of the new glass composition is created via diffusion of ions deep inside the base glass. At this step, ions of the ion exchange treatment include but are not limited to lithium (Li), sodium (Na), potassium (K), rubidium (Rb), cesium (Cs), francium (Fr), silver (Ag), gold (Au), copper (Cu), and combinations thereof. Alkaline-earths may be used as well, although they are bi-valent and less mobile. In an embodiment, lithium (Li) is introduced as the second metal in the base glass at depth to form a new composition because Li readily diffuses and exchanges with sodium present inside the glass base substrate. Other elements could be used that are, for example, also fast diffusers, such as silver (Ag). Use of Ag could lead to coloration of the glass, however.

In an embodiment, the alkali metal oxide is present in the modified base glass in a concentration that is zero at one or both of the first and second surfaces and varies along a portion of the substrate thickness (t) and the concentration along the portion of t is less than that of the alkali metal oxide in the base composition; the oxide of the first metal is present in the modified glass in a concentration that is non-zero at one or both of the first and second surfaces and varies along a portion of the substrate thickness (t) until tₘ where the concentration reaches that of any concentration of the oxide of the first metal in the base composition; and the oxide of the second metal is present in the modified glass in a concentration that is non-zero at one or both of the first and second surfaces and varies along a portion of the substrate thickness (t). By way of the non-limiting example of FIG. 2, which is based on Example 1 where lithium was the second metal, after step II, the Na₂O shows a concentration of 0 mol % at 0 micrometers (“Na₂O Step II” in FIG. 2), increasing to about 8 mol % at a depth of about 175 micrometers, which is less than its concentration in the base composition of 16.51 mol %. Concentration of the K₂O after step II was non-zero at 0 micrometers (“K₂O Step II” in FIG. 2), varying along a portion the substrate thickness (t) until about 100 micrometers (tₘ) where the concentration reached 0 mol %, which was the concentration of the potassium oxide in the base composition. Concentration of the lithium oxide (generally Li₂O) varied from 10 mol % at the surface decreasing to about 8.5 mol % at a depth of about 100 micrometers (“Li₂O Step II” in FIG. 2).

In an embodiment, the tₘ is larger than the tₚ, which indicates that the first metal (e.g., potassium) diffuses farther into the glass substrate during Step II.

The methods herein form glass substrates having a distributed concentration profile. In an embodiment, the distributed concentration comprises: the first alkali metal oxide in an average concentration that is less than its concentration in the base composition and that varies less than or equal to ±1 absolute mol % from a depth of greater than or equal to 0.18t to a center of the substrate; the oxide of the first metal in an average concentration that is more than any of its concentration in the base composition and that varies less than or equal to ±1 absolute mol % from a depth of greater than or equal to 0.18t to a center of the substrate; and the oxide of the second metal in an average concentration that is more than any of its concentration in the base composition and that varies less than or equal to ±1 absolute mol % from a depth of greater than or equal to 0.18t to a center of the substrate. In an embodiment, the substrate thickness is 800 micrometers and 0.18t is 144 micrometers.

With respect to the non-limiting example of FIG. 2 in accordance with Example 1, the Na₂O concentration after Step III was in the range of 6.5-7.5 mol % from the surface to a depth of about 175 micrometers (“Na₂O Step III” in FIG. 2); the K₂O concentration after Step III was about 1.5 mol % at the surface decreasing to near 0 mol % at a depth of about 175 micrometers (“K₂O Step III” in FIG. 2); and the Li₂O concentration after Step III was in the range of 8.5-9 mol % (“Li₂O Step III” in FIG. 2).

After Step III, the average Na₂O concentration in FIG. 2 was about 7 mol %, which is less than its concentration in the base composition. From FIG. 2, it is inferred that the Na₂O concentration varies less than or equal to ±1 absolute mol % from a depth of greater than or equal to 0.18t (144 micrometers) to a center of the substrate. After Step III, the average K₂O concentration in FIG. 2 was about 1 mol %, which is more than its concentration in the base composition. From FIG. 2, it is inferred that the K₂O concentration varies less than or equal to ±1 absolute mol % from a depth of greater than or equal to 0.18t (144 micrometers) to a center of the substrate. After Step III, the average Li₂O concentration in FIG. 2 was about 8.75 mol %, which is more than its concentration in the base composition. From FIG. 2, it is inferred that the Li₂O concentration varies less than or equal to ±1 absolute mol % from a depth of greater than or equal to 0.18t (144 micrometers) to a center of the substrate.

A feature of the methods herein is that with conventional methods, when trying to add lithium into a sodium containing glass that does not have lithium in its original composition, the exchange of lithium (in an IOX bath) for sodium (in the glass) leads to a high tensile stress near the surface. Even small amounts of lithium in the bath of ˜5 wt % LiNO₃/95 wt % NaNO₃ or 5 wt % LiNO₃/95 wt % KNO₃ may lead to glass cracking near the surface or at intermediate depths. As a result, introducing lithium in glasses that originally do not contain lithium can be challenging.

Including Step I in the methods herein overcomes this challenge as an IOX “protection” step by providing stress control. By inducing a high stress in the near and immediate surface in Step I, the amount of lithium being ion-exchanged into the base glass in Step II can be increased. The amount of lithium that can be used in the bath will depend on the original base glass composition, and the amount of protection done initially by the protection step (Step I).

Step II may be repeated 135 as needed to obtain a desired composition.

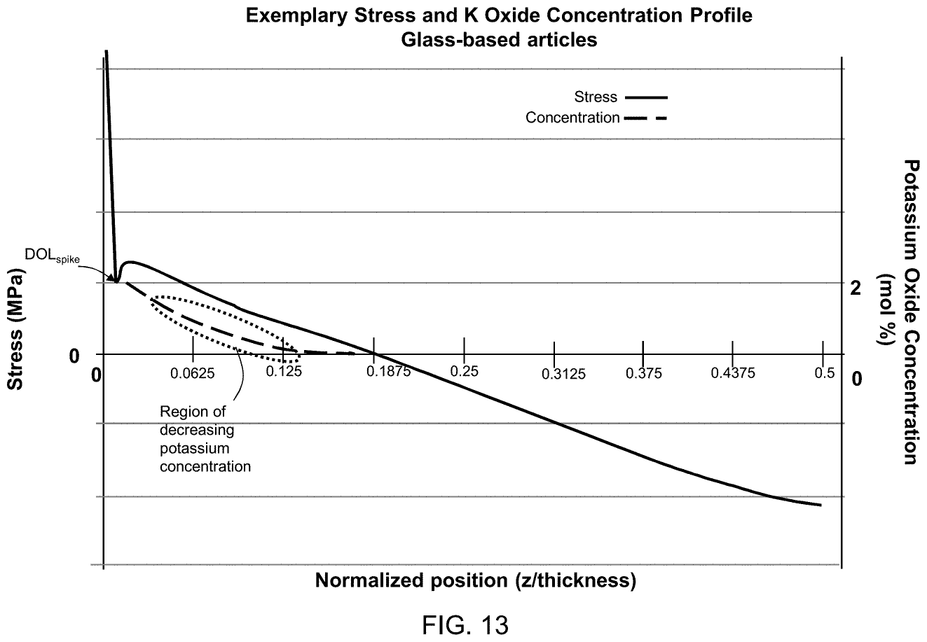

Turning to FIG. 13, which provides a generalized graph of stress and potassium oxide profile versus normalized position for glass-based articles made from the glass substrates herein, there is a region of decreasing potassium concentration located at a depth of greater than a spike depth of layer and less than a depth of compression. This region of decreasing potassium concentration represents a potassium “signature” that is present after lithiation and annealing. Although in a final glass-based article after a desired ion exchange (IOX) is conducted on the inventive glass substrates, potassium concentration near the surface will depend on the IOX conditions used, when starting with the inventive glass substrates, there will still be a similar signature of potassium concentration at depth since usually the typical IOX for strengthening only causes potassium to increase in the immediate surface.

This region is relatively deep inside the article, located at, for example greater than or equal to 0.0625t to less than or equal to 0.1875t, including greater than or equal to 0.0625t to less than or equal to 0.125t, greater than or equal to 0.0625t to less than or equal to 0.09t, greater than or equal to 0.125t to less than or equal to 0.09t, greater than or equal to 0.125t to less than or equal to 0.1875t, and all values and subranges therebetween.

In one or more embodiments, the potassium concentration over the region of decreasing potassium concentration is less than 2 molar %, including greater than 0 mol % to less 2 mol %, greater than or equal to 0.01 mol % to less 2 mol %, greater than or equal to 0.1 mol %, greater than or equal to 0.25 mol %, greater than or equal to 0.5 mol %, greater than or equal to 1 mol %, and/or to less than or equal to 1.9 mol %, less than or equal to 1.8 mol %, less than or equal to 1.5 mol %, less than or equal to 1.4 mol %, less than or equal to 1.3 mol %, less than or equal to 1.2 mol %, less than or equal to 1.1 mol %, including all values and subranges therebetween.

Shape of the potassium concentration profile in the region of decreasing potassium concentration depends on the annealing conditions. In one or more embodiments, the potassium concentration over the region of decreasing potassium concentration is varying, that is, it is not constant.

In one or more embodiments, the potassium concentration over the region of decreasing potassium concentration has a random parabolic shape. In regions of parabolic shape, in one or more embodiments, the potassium concentration over the region decreases in an amount of less than or equal to 2%, including less than or equal to 1.9%, 1.8%, 1.7%, 1.6%, 1.5%, 1.4%, 1.3%, 1.2%, 1.1%, 1%, 0.9%, 0.8%, 0.7%, 0.6%, 0.5%, 0.4%, 0.3%, 0.2%, and 0.1% and/or greater than or equal to 0.1%, including all values and subranges therebetween. %, 90%, and/or less than or equal to 100%, including all values and subranges therebetween. With respect to decreasing in concentration, this is a percentage of the starting value. For example, a 2% decrease of a starting concentration of 2 mol % would be a decrease of 0.04 mol % to result in 1.96 mol %.

In one or more embodiments, the potassium concentration over the region of decreasing potassium concentration has an s-shape. In regions of s-shape, in one or more embodiments, the potassium concentration over the region decreases in an amount of greater than or equal to 50%, including greater than or equal to 55%, 60%, 65%, 70%, 75%, 80%, 85%, 86%, 87%, 88%, 89%, 90%, and/or less than or equal to 100%, including all values and subranges therebetween. With respect to decreasing in concentration, this is a percentage of the starting value. For example, a 50% decrease of a starting concentration of 2 mol % would be a decrease of 1 mol % to result in 1 mol %.

In one or more embodiments, the of decreasing potassium concentration region is located at, for example greater than or equal to 50 micrometers to less than or equal to 150 micrometers, including greater than or equal to 50 micrometers to less than or equal to 1050 micrometers, greater than or equal to 50 micrometers to less than or equal to 75 micrometers, greater than or equal to 100 micrometers to less than or equal to 75 micrometers, greater than or equal to 100 micrometers to less than or equal to 150 micrometers, and all values and subranges therebetween.

In one or more embodiments, an amount of lithium added to the base glass is less than or equal to the alkali content of the base glass. In one or more embodiments, an amount of lithium added to the base glass is an absolute mol % of greater than or equal to 0.1 mol % and/or less than or equal to 25 mol % relative to the lithium in the base glass composition, such as greater than or equal to 0.5 mol %, greater than or equal to 1 mol %, greater than or equal to 2 mol %, greater than or equal to 3 mol %, greater than or equal to 4 mol %, greater than or equal to 5 mol %, greater than or equal to 6 mol %, greater than or equal to 7 mol %, greater than or equal to 8 mol %, greater than or equal to 9 mol %, greater than or equal to 10 mol %, greater than or equal to 11 mol %, greater than or equal to 12 mol %, greater than or equal to 13 mol %, greater than or equal to 14 mol %, greater than or equal to 15 mol %, greater than or equal to 16 mol %, greater than or equal to 17 mol %, greater than or equal to 18 mol %, greater than or equal to 19 mol %, greater than or equal to 20 mol %, or more; and/or less than or equal to 25 mol %, and all values and subranges therebetween.

At Step III 140, the modified base glass is annealed to form a glass substrate of a desired composition. Annealing the modified base glass serves to reduce stress imparted during the first and second ion exchange treatments. At temperatures near the annealing temperature of the glass, stress present in the glass will relax upon exposure to the heat for an adequate amount of time. Upon cooling, the glass forms a substrate with quasi-stress free characteristics, regardless of the ionic distribution inside the glass. In one or more embodiments, annealing removes substantially all stress in the substrate, meaning that stress of the resulting glass substrate is zero or close to zero such that any residual stress does not impact handling or further processing of the substrate. In one or more embodiments, the glass substrate comprises a residual stress of less than or equal to 35 MPa. The residual stress may be less than or equal to 30 MPa, less than or equal to 25 MPa, less than or equal to 20 MPa, less than or equal to 15 MPa, less than or equal to 10 MPa, or less than equal to 5 MPa, less than or equal to 4 MPa, or equal to 3 MPa, less than or equal to 2 MPa, less than or equal to 1 MPa, and all values and subranges therebetween.

Annealing also facilitates further diffusion of the ion exchanged ion so that a distributed concentration profile of the alkali metal oxide, an oxide of the first metal, and an oxide of the second metal is achieved. In one or more embodiments, distributed concentration profiles may be nominally (quasi-) uniform across the thickness. From a surface up to about 0.18t (e.g., from about 100 to about 150 micrometers for a 800 micrometer thick glass), there may be some variation. For example, up to about 0.18t, individual alkali metal ions may have concentrations that vary within a range of ±2.5 absolute mol %. For depths deeper than about 0.18t, individual alkali metal oxides may be present in a concentration that varies less than or equal to ±1 absolute mol % from one or both of the first and second surfaces to a center of the substrate.

Methods herein are advantageous in that new glass compositions are created including improved control of alkali content in the new glass. Some metals such as silver, gold and copper can also be used. Some alkali-earths may also be used, despite their slower diffusivities.

Methods herein are amenable to using sheet glass as-processed. All thicknesses can be accommodated. Examples herein are for 0.8 mm glass. Expected processing times for thicker glasses would be longer; and for thinner glasses, e.g. 0.5 mm, processing times would be reduced.

The new glass compositions after the modification of the original base glass may be quasi-stress free after annealing at temperatures that release the residual stress of the process. That is, residual stress values are preferably low, and it is understood that achieving absolutely stress-free glass may not be practical. Residual stress may be designed to facilitate further processing into glass-based articles.

The new quasi-stress free glass compositions can then be used as a new substrates for strengthening, e.g., ion exchange and/or annealing. In an embodiment, the glass substrates may be cerammed into a glass-ceramic and then ion exchanged.

Unique stress and ion content profiles can be implemented in the new glass compositions.

The methods herein allow for the formation of glasses that would be very difficult or impossible to be done in other platforms such as fusion due to thermovisco-elastic requirements of low viscosity, devitrification/crystallization during glass melting, forming, and the like. Methods of modifying the original base glass into the new glass composition happen at low to intermediate temperatures where such requirements are not at issue.

Utilization of expensive materials such as Li can be targeted in finished articles instead of sheet-sized glasses. Therefore losses in cutting, grinding, polishing, 3D forming are not present making the utilization of expensive materials (such as Li) more efficiently and more environmental friendly.

New base glasses can be specifically designed with specified mechanical properties (e.g., higher moduluses and fracture toughness) and/or that can be cheaply and easily manufactured as a starting point for more complex glasses that are more difficult if not impossible to be manufactured and at cheaper cost. This opens the design space for glasses that can be fusion or rolling-compatible since the final ionic content in the glass will be defined by the posterior process modifications in the base glass. This also can lead to lower costs associated with manufacturing glass substrates.

Methods herein allow for efficient and quick prototyping of different glass compositions that derive from the base glass without the need to make expensive trials to target certain attributes, e.g., flatness or thickness, which can be achieved by the modification of the base glass.

### Base Glasses

Choice of base glass may be based on for example, availability, cost, and based composition. Typically, the base glass has an alkali metal (family 1A of the periodic table) and optionally an alkaline-earth element (family 2A of the periodic table).

Examples of base glasses that may be used may include alkali-alumino silicate glass compositions or alkali-containing aluminoborosilicate glass compositions, though other glass compositions are contemplated. Specific examples of glass-based substrates that may be used include but are not limited to soda-lime silicate glass, an alkali-alumino silicate glass, an alkali-containing borosilicate glass, an alkali-alumino borosilicate glass, an alkali-containing lithium alumino silicate glass, or an alkali-containing phosphate glass. The base glasses have base compositions that may be characterized as ion exchangeable. As used herein, “ion exchangeable” means that a substrate comprising the composition is capable of exchanging cations located at or near the surface of the substrate with cations of the same valence that are either larger or smaller in size.

In one or more embodiments, the base composition has an alkali metal oxide content of 2 mole % or greater.

In an embodiment, an alkali metal oxide content of the base composition comprises by weight: from greater than or equal to 50% to less than or equal to 100% Na₂O, from greater than or equal to 0% to less than or equal to 50% Li₂O, and from greater than or equal to 0 to less than or equal to 50% K₂O; such as from greater than or equal to 70% to less than or equal to 100% Na₂O, from greater than or equal to 0% to less than or equal to 30% Li₂O, and from greater than or equal to 0 to less than or equal to 30% K₂O; or from greater than or equal to 85% to less than or equal to 100% Na₂O, from greater than or equal to 0% to less than or equal to 15% Li₂O, and from greater than or equal to 0 to less than or equal to 15% K₂O; and all values and subranges therebetween.

Exemplary base compositions of base glasses may comprise but are not limited to: a soda-lime silicate, an alkali-alumino silicate, an alkali-containing borosilicate, an alkali-containing aluminoborosilicate, or an alkali-containing phosphosilicate.

In an embodiment, the base composition comprises by mole percent: 55 to 70% SiO₂, 10 to 20% Al₂O₃, 1 to 7% P₂O₅, 0 to 2% Li₂O, 2 to 20% Na₂O, 0 to 10 B₂O₃, and 0 to 10% ZnO, 0 to 4% K₂O, 0 to 8% MgO, 0 to 1% TiO₂, and 0 to 0.5% SnO₂, and all values and subranges therebetween.

In an embodiment, the base composition comprises less than or equal to 20 mol % lithium oxide, such as less than or equal to 19 mol % lithium oxide, less than or equal to 18 mol % lithium oxide, less than or equal to 17 mol % lithium oxide, less than or equal to 16 mol % lithium oxide, less than or equal to 15 mol % lithium oxide, less than or equal to 14 mol % lithium oxide, less than or equal to 13 mol % lithium oxide, less than or equal to 12 mol % lithium oxide, less than or equal to 11 mol % lithium oxide, less than or equal to 10 mol % lithium oxide, less than or equal to 9 mol % lithium oxide, less than or equal to 8 mol % lithium oxide, less than or equal to 7 mol % lithium oxide, less than or equal to 6 mol % lithium oxide, less than or equal to 5 mol % lithium oxide, less than or equal to 4 mol % lithium oxide, less than or equal to 3 mol % lithium oxide, less than or equal to 2 mol % lithium oxide, less than or equal to 1 mol % lithium oxide, less than or equal to 0.5 mol % lithium oxide, less than or equal to 0.1 mol %, and all values and subranges therebetween. In an embodiment, the base composition is free of lithium oxide.

The base glasses may be characterized by the bulk process in which it may be formed. For instance, the glass-based substrates may be characterized as float-formable (i.e., formed by a float process), down-drawable and, in particular, fusion-formable or slot-drawable (i.e., formed by a down draw process such as a fusion draw process or a slot draw process).

Some embodiments of the base glasses described herein may be formed by a down-draw process. Down-draw processes produce base glasses having a uniform thickness that possess relatively pristine surfaces. Because the average flexural strength of a glass article is controlled by the amount and size of surface flaws, a pristine surface that has had minimal contact has a higher initial strength. In addition, down drawn base glasses have a very flat, smooth surface that can be used in its final application without costly grinding and polishing.

Some embodiments of the base glasses may be described as fusion-formable (i.e., formable using a fusion draw process). The fusion process uses a drawing tank that has a channel for accepting molten glass raw material. The channel has weirs that are open at the top along the length of the channel on both sides of the channel. When the channel fills with molten material, the molten glass overflows the weirs. Due to gravity, the molten glass flows down the outside surfaces of the drawing tank as two flowing glass films. These outside surfaces of the drawing tank extend down and inwardly so that they join at an edge below the drawing tank. The two flowing glass films join at this edge to fuse and form a single flowing glass sheet. The fusion draw method offers the advantage that, because the two glass films flowing over the channel fuse together, neither of the outside surfaces of the resulting glass article comes in contact with any part of the apparatus. Thus, the surface properties of the fusion drawn base glass are not affected by such contact. The fusion forming process results in a glass sheet having a “fusion line” where the two glass films overflowing each side of the drawing tank meet. A fusion line is formed where the two flowing glass films fuse together. The presence of a fusion line is one manner of identifying a fusion drawn glass. The fusion line may be seen as an optical distortion when the glass is viewed under an optical microscope.

Some embodiments of the base glasses described herein may be formed by a slot draw process. The slot draw process is distinct from the fusion draw method. In slot draw processes, the molten raw material glass is provided to a drawing tank. The bottom of the drawing tank has an open slot with a nozzle that extends the length of the slot. The molten glass flows through the slot/nozzle and is drawn downward as a continuous glass sheet and into an annealing region.

### Ion Exchange (IOX) Treatment

Chemical strengthening of base glasses is done by placing the ion-exchangeable glass substrates in a molten bath containing cations (e.g., K+, Na+, Ag+, etc) that diffuse into the glass while the smaller alkali ions (e.g., Na+, Li+) of the glass diffuse out into the molten bath. The replacement of the smaller cations by larger ones creates compressive stresses near the top surface of glass. Tensile stresses are generated in the interior of the glass to balance the near-surface compressive stresses.

With respect to ion exchange processes, they may independently be a thermal-diffusion process or an electro-diffusion process. Non-limiting examples of ion exchange processes in which glass is immersed in multiple ion exchange baths, with washing and/or annealing steps between immersions, are described in U.S. Pat. No. 8,561,429, by Douglas C. Allan et al., issued on Oct. 22, 2013, entitled “Glass with Compressive Surface for Consumer Applications,” and claiming priority from U.S. Provisional Patent Application No. 61/079,995, filed Jul. 11, 2008, in which glass is strengthened by immersion in multiple, successive, ion exchange treatments in salt baths of different concentrations; and U.S. Pat. No. 8,312,739, by Christopher M. Lee et al., issued on Nov. 20, 2012, and entitled “Dual Stage Ion Exchange for Chemical Strengthening of Glass,” and claiming priority from U.S. Provisional Patent Application No. 61/084,398, filed Jul. 29, 2008, in which glass is strengthened by ion exchange in a first bath is diluted with an effluent ion, followed by immersion in a second bath having a smaller concentration of the effluent ion than the first bath. The contents of U.S. Pat. Nos. 8,561,429 and 8,312,739 are incorporated herein by reference in their entireties.

With respect to salts to use for ion exchange, nitrate salts are conventional but any suitable salts or combination of salts may be used. For example, the anions to deliver cations for ion exchange may be selected from the group consisting of: nitrates, sulfates, carbonates, chlorides, fluorides, borates, phosphates, and combinations thereof. In one or more embodiments, first and second ion exchange treatments independently comprise a bath temperature in the range of from greater than or equal to 300° C. to less than or equal to 1000° C.

In an embodiment, ions are delivered by molten salts whose anions include nitrates, and the first and second ion exchange treatments independently comprise a bath temperature in the range of from greater than or equal to 300° C. to less than or equal to 600° C.

In an embodiment, ions are delivered by molten salts whose anions include sulfates, and the first and second ion exchange treatments independently comprise a bath temperature in the range of from greater than or equal to 300° C. to less than or equal to 900° C.

In an embodiment, ions are delivered by molten salts whose anions include carbonates, and the first and second ion exchange treatments independently comprise a bath temperature in the range of from greater than or equal to 300° C. to less than or equal to 850° C.

In an embodiment, ions are delivered by molten salts whose anions include fluorides, and the first and second ion exchange treatments independently comprise a bath temperature in the range of from greater than or equal to 300° C. to less than or equal to 900° C.

In an embodiment, ions are delivered by molten salts whose anions include chlorides, and the first and second ion exchange treatments independently comprise a bath temperature in the range of greater than or equal to 300° C. to less than or equal to 850° C.

In an embodiment, ions are delivered by molten salts whose anions include borates, and the first and second ion exchange treatments independently comprise a bath temperature in the range of greater than or equal to 300° C. to less than or equal to 900° C.

In an embodiment, ions are delivered by molten salts whose anions include phosphates, and the first and second ion exchange treatments independently comprise a bath temperature in the range of greater than or equal to 300° C. to less than or equal to 1000° C.

Ion exchange treatments results in a glass having an alkali metal oxide having a non-zero concentration that varies from one or both of first and second surfaces to a depth of layer (DOL) with respect to the metal oxide. The non-zero concentration may vary along a portion of the article thickness. In some embodiments, the concentration of the alkali metal oxide is non-zero and varies, both along a thickness range from about 0·t to about 0.3·t. In some embodiments, the concentration of the alkali metal oxide is non-zero and varies along a thickness range from about 0·t to about 0.35·t, from about 0·t to about 0.4·t, from about 0·t to about 0.45·t, from about 0·t to about 0.48·t, or from about 0·t to about 0.50·t. The variation in concentration may be continuous along the above-referenced thickness ranges. Variation in concentration may include a change in metal oxide concentration of about 0.2 mol % or more along a thickness segment of about 100 micrometers. The change in metal oxide concentration may be about 0.3 mol % or more, about 0.4 mol % or more, or about 0.5 mol % or more along a thickness segment of about 100 micrometers. This change may be measured by known methods in the art including microprobe.

In some embodiments, the variation in concentration may be continuous along thickness segments in the range from about 10 micrometers to about 30 micrometers. In some embodiments, the concentration of the alkali metal oxide decreases from the first surface to a value between the first surface and the second surface and increases from the value to the second surface.

The concentration of alkali metal oxide may include more than one metal oxide (e.g., a combination of Na₂O and K₂O). In some embodiments, where two metal oxides are utilized and where the radius of the ions differ from one or another, the concentration of ions having a larger radius is greater than the concentration of ions having a smaller radius at shallow depths, while at deeper depths, the concentration of ions having a smaller radius is greater than the concentration of ions having larger radius.

In one or more embodiments, the alkali metal oxide concentration gradient extends through a substantial portion of the thickness t of the article. In some embodiments, the concentration of the metal oxide may be about 0.5 mol % or greater (e.g., about 1 mol % or greater) along the entire thickness of the first and/or second section, and is greatest at a first surface and/or a second surface 0·t and decreases substantially constantly to a value between the first and second surfaces. At that value, the concentration of the metal oxide is the least along the entire thickness t; however the concentration is also non-zero at that point. In other words, the non-zero concentration of that particular metal oxide extends along a substantial portion of the thickness t (as described herein) or the entire thickness t. The total concentration of the particular metal oxide in the glass-based article may be in the range from about 1 mol % to about 20 mol %.

The concentration of the alkali metal oxide may be determined from a baseline amount of the metal oxide in a glass-based substrate ion exchanged to form a glass-based article.

### Annealing

Annealing methods may be conducted by methods in the art. Time and temperature may be specific to different glass compositions. Annealing is generally conducted at temperatures above the strain point of the glass. Rates of heating and cooling are chosen based on glass compositions and desired properties.

FIG. 4 provides an annealing process in accordance with an embodiment. In an embodiment, the annealing has a hold time of 3 hours at a hold temperature of 630° C. Hold temperatures may be conducted in the range of greater than or equal to 300° C. to less than or equal to 800° C., such as in the range of greater than or equal to 500° C. to less than or equal to 700° C.

In an embodiment, a rate of heating of 10° C./min is used until the annealing temperature of 630° C. is achieved. In an embodiment, rates of cooling are: initially 3° C./min and 5° C./min, which permits gradual cooling and avoiding additional induction of stress during the cooling process. Thereafter, a faster rate of cooling of 10° C./min may be used.

The faster rates of heating and cooling of 10° C./min may be used, unless thermal shock is of concern for a particular application. Depending on the temperatures, times and cycle times used more or less residual stress may still be present in the glass substrate that deviates from the desired absolute null stress. This provides another level of control for the process where the annealing cycle can also be used to provide an initial residual stress to be added to the substrate.

Annealing of ion exchanged glasses can result in removal of most if not all stress and diffusion of ions.

### Glass-Based Articles

Glass-based articles may be formed by strengthening the glass substrates disclosed herein by ion exchange and/or annealing methods discussed with respect to the base glasses. Upon strengthening of the glass substrates, resulting glass-based articles will have stress profiles designed in accordance with specifications for various applications.

With specific respect to chemical strengthening of the glass substrates compressive stresses are generated near the top surface of glass, and tensile stresses are generated in the interior of the glass to balance the near-surface compressive stresses. A stress profile generated upon ion exchange due to a non-zero concentration of a metal oxide(s) that varies from a first surface into the glass substrate.

In one or more embodiments, any glass-based article herein comprises one or more of the following features, alone or in combination:

a peak compressive stress (CS) that is greater than or equal to 200 MPa, greater than or equal to 250 MPa, greater than or equal to 300 MPa, greater than or equal to 450 MPa, greater than or equal to 500 MPa, greater than or equal to 550 MPa, greater than or equal to 600 MPa, greater than or equal to 650 MPa, greater than or equal to 700 MPa, greater than or equal to 750 MPa, greater than or equal to 800 MPa, greater than or equal to 850 MPa, greater than or equal to 900 MPa, greater than or equal to 950 MPa, greater than or equal to 1000 MPa, greater than or equal to 1050 MPa, greater than or equal to 1100 MPa, greater than or equal to 1150 MPa, or greater than or equal to 1200 MPa, or more, including all values and subranges therebetween;

a compressive stress at a knee (CSₖ) that is greater than or equal to 50 MPa, greater than or equal to 55 MPa, greater than or equal to 60 MPa, greater than or equal to 65 MPa, greater than or equal to 70 MPa, greater than or equal to 75 MPa, greater than or equal to 80 MPa, greater than or equal to 85 MPa, greater than or equal to 90 MPa, greater than or equal to 95 MPa, greater than or equal to 100 MPa, greater than or equal to 105 MPa, greater than or equal to 110 MPa, greater than or equal to 115 MPa, greater than or equal to 120 MPa, greater than or equal to 125 MPa, greater than or equal to 130 MPa, greater than or equal to 135 MPa, greater than or equal to 140 MPa, greater than or equal to 145 MPa, greater than or equal to 150 MPa, greater than or equal to 155 MPa, greater than or equal to 160 MPa, greater than or equal to 170 MPa, greater than or equal to 180 MPa, greater than or equal to 190 MPa, greater than or equal to 200 MPa, greater than or equal to 210 MPa, greater than or equal to 220 MPa, greater than or equal to 230 MPa, greater than or equal to 240 MPa, and/or less than or equal to 250 MPa, including all values and subranges therebetween;

a central tension (CT) that is greater than or equal to 50 MPa, greater than or equal to 55 MPa, greater than or equal to 60 MPa, greater than or equal to 65 MPa, greater than or equal to 70 MPa, greater than or equal to 75 MPa, greater than or equal to 80 MPa, greater than or equal to 85 MPa, greater than or equal to 90 MPa, greater than or equal to 95 MPa, greater than or equal to 100 MPa, greater than or equal to 110 MPa, and/or less than or equal to 120 MPa, including all values and subranges therebetween;

a depth of compression (DOC) that is greater than or equal to 0.11t, 0.12t, 0.13t, 0.14t, 0.15t, 0.16t, 0.17t, 0.18t, 0.19t, 0.20t, 0.21t, 0.22t, and/or less than or equal to 0.30t, 0.29t, 0.28t, 0.27t, 0.26t, 0.25t, 0.24t, 0.23t, including all values and subranges therebetween;

a spike depth of layer (DOLₛₚ) that is greater than or equal to 0.007t, greater than or equal to 0.008t, greater than or equal to 0.009t, greater than or equal to 0.01t, greater than or equal to 0.011t, greater than or equal to 0.012t, greater than or equal to 0.013t, greater than or equal to 0.014t, greater than or equal to 0.015t, greater than or equal to 0.016t, greater than or equal to 0.017t, greater than or equal to 0.018t, greater than or equal to 0.019t, greater than or equal to 0.02t, greater than or equal to 0.021t, greater than or equal to 0.022t, greater than or equal to 0.023t, greater than or equal to 0.024t, and/or less than or equal to 0.025t including all values and subranges therebetween; and/or at a depth from a surface of greater than or equal to 6.5 micrometers, greater than or equal to 7 micrometers, greater than or equal to 8 micrometers, greater than or equal to 9 micrometers, greater than or equal to 10 micrometers, greater than or equal to 11 micrometers, greater than or equal to 12 micrometers, greater than or equal to 13 micrometers, greater than or equal to 14 micrometers, greater than or equal to 15 micrometers, greater than or equal to 16 micrometers, greater than or equal to 17 micrometers, greater than or equal to 18 micrometers, greater than or equal to 19 micrometers, and/or less than or equal to 20 micrometers, including all values and subranges therebetween; and

lithium oxide (Li₂O) in a central composition in an amount of greater than 0.1 mol %; Li₂O content may be greater than or equal to 0.5 mol %, greater than or equal to 1 mol %, greater than or equal to 2 mol %, greater than or equal to 3 mol %, greater than or equal to 5 mol %, greater than or equal to 10 mol %, greater than or equal to 11 mol %, greater than or equal to 12 mol %, greater than or equal to 13 mol %, greater than or equal to 14 mol %, and/or less than or equal to 15 mol %, and all values and subranges therein.

In one or more embodiments, glass-based articles herein comprise a fusion line.

In one or more embodiments, glass-based articles comprise a fusion line and a lithium oxide (Li₂O) in an amount of greater than or equal to 11 mol %. Li₂O content may be greater than or equal to 11.1 mol %, greater than or equal to 11.5 mol %, greater than or equal to 12 mol %, greater than or equal to 13 mol %, greater than or equal to 14 mol %, and/or less than or equal to 15 mol %, and all values and subranges therein.

The amount of lithium in a glass composition has an effect on the liquidus viscosity. In embodiments, the liquidus viscosity is less than or equal to 300 kP, such as less than or equal to 275 kP, less than or equal to 250 kP, less than or equal to 225 kP, less than or equal to 200 kP, less than or equal to 175 kP, or less than or equal to 150 kP. In other embodiments, the liquidus viscosity is greater than or equal to 100 kP, greater than or equal to 125 kP, greater than or equal to 150 kP, greater than or equal to 175 kP, greater than or equal to 200 kP, greater than or equal to 225 kP, greater than or equal to 250 kP, or greater than or equal to 275 kP. In yet other embodiments, the liquidus viscosity is from greater than or equal to 100 kP to less than or equal to 300 kP, greater than or equal to 125 kP to less than or equal to 275 kP, greater than or equal to 150 kP to less than or equal to 250 kP, or greater than or equal to 175 kP to less than or equal to 225 kP and all ranges and sub-ranges between the foregoing values. The liquidus viscosity values are determined by the following method. First the liquidus temperature of the glass is measured in accordance with ASTM C829-81 (2015), titled “Standard Practice for Measurement of Liquidus Temperature of Glass by the Gradient Furnace Method”. Next the viscosity of the glass at the liquidus temperature is measured in accordance with ASTM C965-96(2012), titled “Standard Practice for Measuring Viscosity of Glass Above the Softening Point”.

### End Products

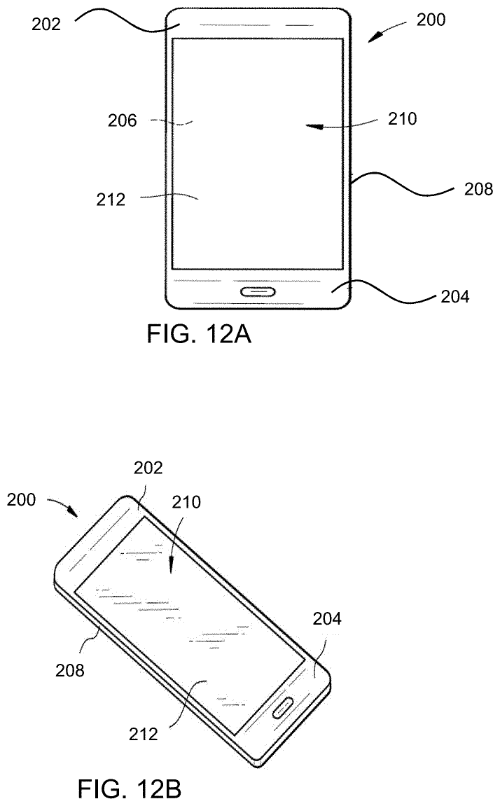

An exemplary article incorporating any of the glass-based articles disclosed herein is shown in FIGS. 12A and 12B. Specifically, FIGS. 12A and 12B show a consumer electronic device 200 including a housing 202 having front 204, back 206, and side surfaces 208; electrical components (not shown) that are at least partially inside or entirely within the housing and including at least a controller, a memory, and a display 210 at or adjacent to the front surface of the housing; and a cover substrate 212 at or over the front surface of the housing such that it is over the display. In some embodiments, at least one of a portion of the housing and the cover substrate 212 may include any of the strengthened articles disclosed herein.

### EMBODIMENTS

The disclosure includes the following numbered embodiments:

### Embodiment 1

A method of manufacturing a glass substrate comprising: obtaining a base glass having opposing first and second surfaces defining a thickness (t), and comprising a base composition containing an alkali metal oxide; exposing the base glass to a first ion exchange treatment including ions of a first metal to form a protected base glass; exposing the protected base glass to a second ion exchange treatment including the ions of the first metal and ions of a second metal to form a modified base glass; and annealing the modified base glass to reduce stress and to obtain a distributed concentration profile of the alkali metal oxide, an oxide of the first metal, and an oxide of the second metal, thereby forming the glass substrate.

### Embodiment 2

A method of manufacturing a glass substrate comprising: obtaining a base glass having opposing first and second surfaces defining a thickness (t), and comprising a base composition containing an alkali metal oxide; exposing the base glass to a first ion exchange treatment including ions of a first metal to form a protected base glass; exposing the protected base glass to a second ion exchange treatment including the ions of the first metal and ions of a second metal to form a modified base glass; and annealing the modified base glass to reduce residual stress thereby forming the glass substrate; wherein a concentration of an oxide of the second metal in a center of the glass substrate is higher than a concentration of the oxide of the second metal in the base composition.

### Embodiment 3

The method of any preceding embodiment, wherein the glass substrate comprises a residual stress of less than or equal to 35 MPa.

### Embodiment 4

The method of any preceding embodiment, wherein the glass substrate comprises a residual stress of less than or equal to 5 MPa.

### Embodiment 5

The method of any preceding embodiment, wherein after exposing the base glass to the first ion exchange treatment: the alkali metal oxide is present in the protected base glass in a concentration that is zero at one or both of the first and second surfaces and varies along a portion of the substrate thickness (t) until the concentration reaches that of the alkali metal oxide in the base composition; and the oxide of the first metal is present in the protected glass in a concentration that is non-zero at one or both of the first and second surfaces and varies along a portion of the substrate thickness (t) until tₚ where the concentration reaches that of any concentration of the oxide of the first metal in the base composition.

### Embodiment 6

The method of any preceding embodiment, wherein after exposing the protected base glass to a second ion exchange treatment including the ions of the first metal and the ions of the second metal: the alkali metal oxide is present in the modified base glass in a concentration that is zero at one or both of the first and second surfaces and varies along a portion of the substrate thickness (t) and the concentration along the portion of t is less than that of the alkali metal oxide in the base composition; the oxide of the first metal is present in the modified glass in a concentration that is non-zero at one or both of the first and second surfaces and varies along a portion of the substrate thickness (t) until tₘ where the concentration reaches that of any concentration of the oxide of the first metal in the base composition; and the oxide of the second metal is present in the modified glass in a concentration that is non-zero at one or both of the first and second surfaces and varies along a portion of the substrate thickness (t).

### Embodiment 7

The method of the preceding embodiment, wherein tₘ is larger than the tₚ.

### Embodiment 8

The method of embodiment 1, wherein the distributed concentration profile comprises: the first alkali metal oxide in an average concentration that is less than its concentration in the base composition and that varies less than or equal to ±1 absolute mol % from a depth of greater than or equal to 0.18t to a center of the substrate; the oxide of the first metal in an average concentration that is more than any of its concentration in the base composition and that varies less than or equal to ±1 absolute mol % from a depth of greater than or equal to 0.18t to a center of the substrate; and the oxide of the second metal in an average concentration that is more than any of its concentration in the base composition and that varies less than or equal to ±1 absolute mol % from a depth of greater than or equal to 0.18t to a center of the substrate.

### Embodiment 9

The method of any preceding embodiment, wherein the base glass is obtained from a bulk process selected from the group consisting of: float technique, fusion technique, rolling technique, slot draw technique, and crucible melting.

### Embodiment 10

The method of any preceding embodiment, wherein the first and second metals are independently selected from the group consisting of: lithium (Li), sodium (Na), potassium (K), rubidium (Rb), cesium (Cs), francium (Fr), silver (Ag), gold (Au), copper (Cu), and combinations thereof.

### Embodiment 11

The method of the preceding embodiment, wherein the first and second metals are alkali metals independently selected from the group consisting of: lithium (Li), sodium (Na), potassium (K), rubidium (Rb), cesium (Cs), and combinations thereof.

### Embodiment 12

The method of any preceding embodiment, wherein the annealing is conducted at a hold temperature in the range of 300 to 800° C.

### Embodiment 13

The method of any preceding embodiment, wherein the first and second ion exchange treatments independently comprise a bath temperature in the range of from greater than or equal to 300° C. to less than or equal to 1000° C.

### Embodiment 14

The method of any preceding embodiment, wherein the ions of first and second metals are delivered by molten salts whose anions are independently selected from the group consisting of: nitrate, sulfate, carbonate, fluoride, chloride, borates, phosphates, and combinations thereof.

### Embodiment 15

A method of manufacturing a glass substrate comprising: obtaining a base glass having opposing first and second surfaces defining a substrate thickness (t), and comprising a base composition containing sodium oxide; exposing the base glass that to a first ion exchange treatment including a molten potassium salt to form a protected base glass; exposing the protected base glass to a second ion exchange treatment including the molten potassium salt and a molten lithium salt to form a modified base glass; and annealing the modified base glass to reduce stress and to obtain a distributed concentration profile of the sodium oxide, potassium oxide, and lithium oxide, thereby forming the glass substrate.

### Embodiment 16

The method of the preceding embodiment, wherein the glass substrate comprises a residual stress of less than or equal to 35 MPa.

### Embodiment 17

The method of the preceding embodiment, wherein the glass substrate comprises a residual stress of less than or equal to 5 MPa.

### Embodiment 18

The method of one of embodiment 15 to the preceding embodiment, wherein the distributed concentration profile comprises: the sodium oxide in an average concentration that is less than its concentration in the base composition and that varies less than or equal to ±1 absolute mol % from a depth of greater than or equal to 0.18t to a center of the substrate; the potassium oxide in an average concentration that is more than any of its concentration in the base composition and that varies less than or equal to ±1 absolute mol % from a depth of greater than or equal to 0.18t to a center of the substrate; and the lithium oxide in an average concentration that is more than any of its concentration in the base composition and that varies less than or equal to ±1 absolute mol % from a depth of greater than or equal to 0.18t to a center of the substrate.

### Embodiment 19

The method of one of embodiment 15 to the preceding embodiment, wherein the base glass is obtained from a bulk process selected from the group consisting of: float technique, fusion technique, rolling technique, crucible melting, and slot draw technique.

### Embodiment 20

The method of any of embodiment 15 to the preceding embodiment, wherein an alkali metal oxide content of the base composition comprises by weight: from greater than or equal to 50% to less than or equal to 100% Na₂O, from greater than or equal to 0% to less than or equal to 50% Li₂O, and from greater than or equal to 0 to less than or equal to 50% K₂O.

### Embodiment 21

The method of any of embodiment 15 to the preceding embodiment, wherein the base composition comprises by mole percent: 55 to 70% SiO₂, 10 to 20% Al₂O₃, 1 to 7% P₂O₅, 0 to 2% Li₂O, 2 to 20% Na₂O, 0 to 10 B₂O₃, and 0 to 10% ZnO, 0 to 4% K₂O, 0 to 8% MgO, 0 to 1% TiO₂, and 0 to 0.5% SnO₂.

### Embodiment 22

The method of any of embodiment 15 to the preceding embodiment, wherein the molten potassium salt and the molten lithium salt independently comprise anions selected from the group consisting of: nitrate, sulfate, carbonate, fluoride, chloride, borate, and phosphate, and combinations thereof.

### Embodiment 23

The method of any of embodiment 15 to the preceding embodiment, wherein the first and second ion exchange treatments independently comprise a bath temperature in the range of greater than or equal to 300° C. to less than or equal to 1000° C.

### Embodiment 24

The method of the preceding embodiment, wherein the ions of first and second metals are delivered by molten salts whose anions are nitrates, and the first and second ion exchange treatments independently comprise a bath temperature in the range of greater than or equal to 300° C. to 600° C.

### Embodiment 25

A glass substrate made according to any preceding embodiment.

### Embodiment 26

A method of making a glass-based article comprising: obtaining the glass substrate of the preceding embodiment; strengthening the glass substrate by ion exchange and/or annealing to form the glass-based article.

### Embodiment 27

A glass-based article made according to the preceding embodiment.

### Embodiment 28

A glass-based article comprising: silicon dioxide (SiO₂); aluminum oxide (Al₂O₃); and lithium oxide (Li₂O) in an amount of greater than 11 mol %; and a fusion line.

### Embodiment 29

The glass-based article of the preceding embodiment comprising a liquidus viscosity of less than or equal to 300 kP.

### Embodiment 30

A glass-based article comprising: opposing first and second surfaces defining a thickness (t); silicon dioxide (SiO₂); aluminum oxide (Al₂O₃); sodium oxide (Na₂O); lithium oxide (Li₂O); and potassium oxide (K₂O), wherein a potassium oxide concentration profile of the article comprises a region of decreasing potassium concentration located at a depth of greater than a spike depth of layer and less than or equal to a depth of compression.

### Embodiment 31

The glass-based article of embodiment 30, wherein the potassium concentration over the region of decreasing potassium concentration has a random parabolic shape.

### Embodiment 32

The glass-based article of the preceding embodiment, wherein the potassium concentration over the region of decreasing potassium concentration decreases in an amount of less than or equal to 2%.

### Embodiment 33

The glass-based article of embodiment 30, wherein the potassium concentration over the region of decreasing potassium concentration has an s-shape.

### Embodiment 34

The glass-based article of the preceding embodiment, wherein the potassium concentration over the region of decreasing potassium concentration decreases in an amount of greater than or equal to 50%.

### Embodiment 35

The glass-based article of one of embodiment 30 to 34, wherein the region of decreasing potassium concentration is located in a range of 50 micrometers from the first or second surface to 100 micrometers from the first or second surface.

### Embodiment 36

The glass-based article of one of embodiment 30 to 35, wherein the potassium concentration over the region of decreasing potassium concentration is less than 2 molar %.

### Embodiment 37

A consumer electronic product comprising: a housing having a front surface, a back surface, and side surfaces; electrical components provided at least partially within the housing, the electrical components including at least a controller, a memory, and a display, the display being provided at or adjacent the front surface of the housing; and a cover disposed over the display; wherein a portion of at least one of the housing and the cover comprises the glass-based article of any of embodiments 27 to 36.

### EXAMPLES

Various embodiments will be further clarified by the following examples.

In all of the examples, the base glass had a thickness of 800 micrometers (μm).

Base glass “A” is a Li-free alkali-aluminosilicate glass having an approximate composition of: 57.43 mol % SiO₂, 16.10 mol % Al₂O₃, 17.05 mol % Na₂O, 2.81 mol % MgO, 0.003 mol % TiO₂, 6.54 mol % P₂O₅, and 0.07 mol % SnO₂. Base glass “A” is made by a fusion technique.

Base glass “B” is a Li-containing alkali-aluminosilicate glass having an approximate composition of: 63.60 mol % SiO₂, 15.67 mol % Al₂O₃, 10.81 mol % Na₂O, 6.24 mol % Li₂O, 1.16 mol % ZnO, 0.04 mol % SnO₂, and 2.48 mol % P₂O₅. Base glass “B” is made by a fusion technique.

### Example 1

A sheet of base glass “A” was obtained having a measured sodium (Na) oxide content of 16.51 mol %, which was all of the alkali metals in the base glass. There were no significant amounts of potassium or lithium. FIG. 2 provides a graph of oxide molar concentration as a function of depth in the glass from a first surface (0 micrometers) was measured by Glow Discharge-Optical Emission Spectroscopy (GD-OES) in conjunction with flame emission spectroscopy used for calibration after each step. Overall precision of the measurement was approximately 0.2 mol %. In FIG. 2, it is shown that the Na₂O base concentration was 16.51 mol % from the surface into the depth of the glass.

In Step I, the base glass was exposed to an ion exchange treatment comprising a bath of 100 wt % potassium nitrate (KNO₃) at 390° C. for 4 hours to form a protected base glass. In FIG. 2, the Na₂O concentration after Step I was 0 mol % at the surface increasing back to 16.51 mol % at a depth of about 50 micrometers; the K₂O concentration after Step I was 16.51 mol % at the surface decreasing to 0 mol % at a depth of about 50 micrometers (tₚ); and the Li₂O concentration after Step I was 0 mol %. Diffusion of the potassium into the glass at a level of 1 mol % or more was achieved up to a depth of ˜35 micrometers. At the surface, reduction of the sodium and increase of the potassium content represents the total number of alkali present in the glass.

In Step II, the protected base glass was exposed to a deep Li diffusion ion exchange treatment comprising a bath of 60 wt % potassium nitrate (KNO₃) and 40 wt % lithium nitrate (LiNO₃) at 460° C. for 8 hours to form a modified base glass. In FIG. 2, the Na₂O concentration after Step II was 0 mol % at the surface increasing to about 8 mol % at a depth of about 175 micrometers; the K₂O concentration after Step II was about 6.5 mol % at the surface decreasing to 0 mol % at a depth of about 100 micrometers (tₘ); and the Li₂O concentration after Step II was 10 mol % at the surface decreasing to about 8.5 mol % at a depth of about 100 micrometers. Step II uploads a substantial amount of lithium to the glass. Longer times or higher temperature would increase the amount of lithium of the modified glass. Higher or lower amount of lithium in the bath would also increase or reduce the amount of lithium of the modified glass. Since lithium is very small and mobile compared to potassium, it diffuses deep inside the glass while the remaining potassium in the bath continues to protect the surface and avoids excessive tensile stress to occur in the surface and inside the glass. This therefore avoids the formation of cracks in the substrate under process that would damage the sample.

In Step III, the modified base glass was annealed in a convection oven at 630° C. for 3 hours to form the glass substrate in accordance with the heating and cooling parameters of FIG. 4. In FIG. 2, it is shown that the ions diffused resulting in a distributed concentration profile where the Na₂O concentration after Step III was in the range of 6.5-7.5 mol % from the surface to a depth of about 175 micrometers; the K₂O concentration after Step III was about 1.5 mol % at the surface decreasing to near 0 mol % at a depth of about 175 micrometers; and the Li₂O concentration after Step III was in the range of 8.5-9 mol %.

The concentration profiles after Step III show a more uniform ion distribution through depth as compared to Steps I and II. In addition, the annealing also removes to a large extent the residual stress induced by the previous ion-exchange steps. Potassium, which is relatively slow to diffuse, still provides a gradual change in potassium concentration through depth. This leads to a small taper in the concentration of lithium and sodium in the surface towards the center of the sample. The taper in concentration could be addressed by using a higher annealing temperature and/or longer annealing time, both of which would further diffuse and continue to reduce the tapered concentration of ions in the sample.

In Example 1, a new glass composition comprising 8.5-9 mol % Li₂O was formed from a base glass that did not contain any lithium.

### Example 2

A series of glass substrates was formed in accordance with the general Steps I-III and the base glass “A” of Example 1. Table 1 provides a summary of the process parameters and resulting Li₂O content of the glass substrate. For Step I and Step II, bath concentration, time, and temperature of the ion-exchange process used are listed. For Step III, hold time and hold temperature of the annealing step is listed. Step I and Step III were the same. Step III was in accordance with the process of FIG. 4. In Step II, which introduced lithium inside the glass, variations in bath composition and temperatures were tested. The amount of lithium present in the final substrate can be changed.

TABLE 1

| | | | | Li₂O at |
|---|---|---|---|---|
| | | | | 0 μm |
| Sample | Step I | Step II | Step III | (mol %) |
| 2A | 100 wt % KNO₃ - | 80 wt % KNO₃/20 wt % | 3 h - | ~0.76 |
| | 4 h - 390° C. | LiNO₃ - 4 h - 380° C. | 630° C. | |
| 2B | 100 wt % KNO₃ - | 70 wt % KNO₃/30 wt % | 3 h - | ~6.60 |
| | 4 h - 390° C. | LiNO₃ - 8 h - 460° C. | 630° C. | |
| 2C | 100 wt %KNO₃ - | 60 wt % KNO₃/40 wt % | 3 h - | ~8.38 |
| | 4 h - 390° C. | LiNO₃ - 8 h - 460° C. | 630° C. | |

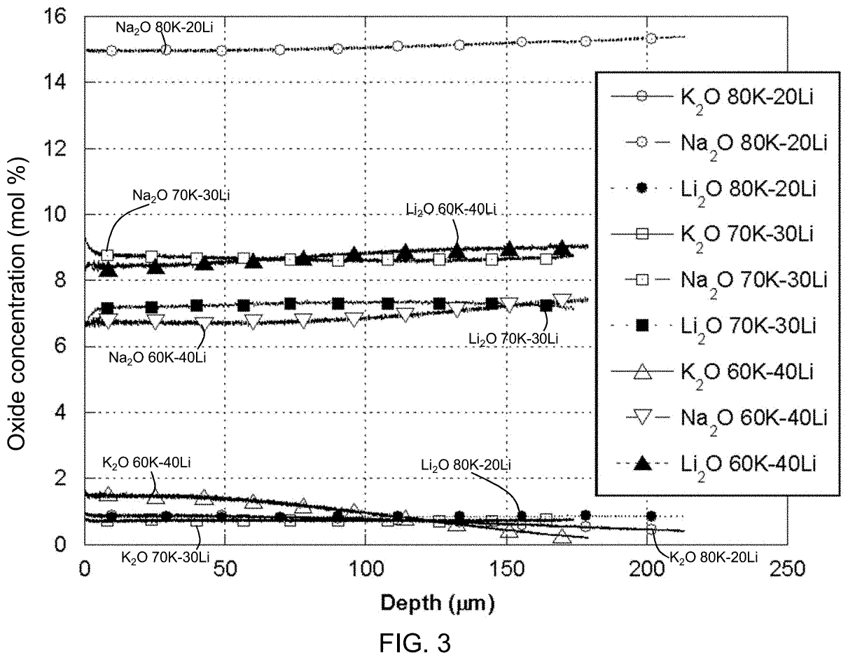

FIG. 3 provides a graph of oxide molar concentration of the glass substrate (after Step III) as a function of depth in the glass from a first surface (0 micrometers) was measured by Glow Discharge-Optical Emission Spectroscopy (GD-OES). Overall precision of the measurement was approximately 0.2 mol %.

For a low wt % of LiNO₃ at lower temperatures in the bath only a small lithium content was introduced. A larger wt % of LiNO₃ in the bath was used to increase the amount of lithium in conjunction with higher temperatures and diffusion time.

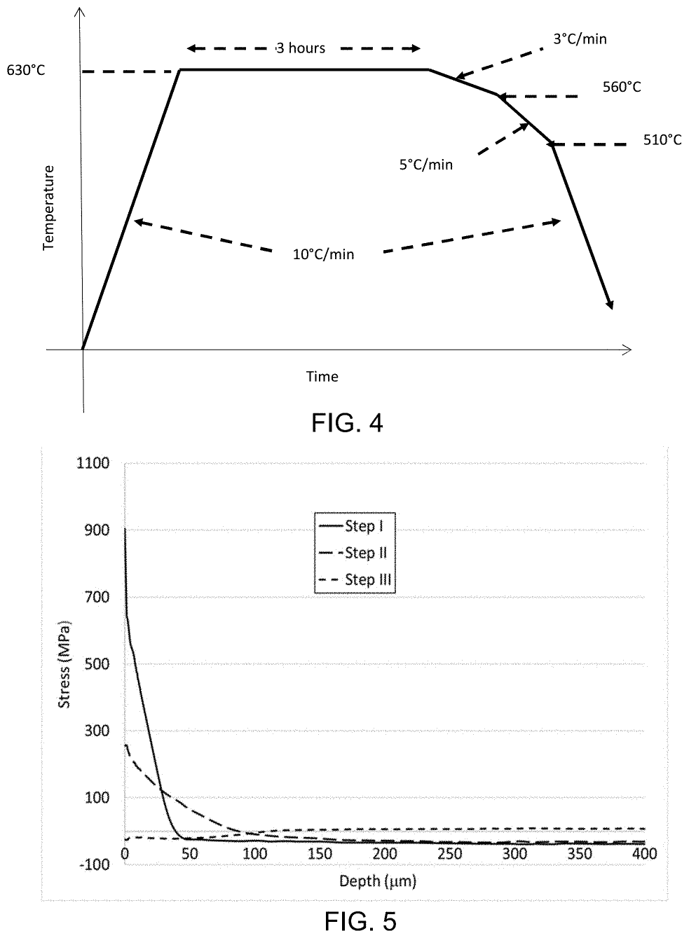

FIG. 5 provides graph of stress (MPa) versus depth (micrometers) from a surface for Steps I, II, and III according to Table 1 for the embodiment where Step II was 60 wt % KNO₃/40 wt % LiNO₃ at 460° C. for 8 hours. Measurement was made by refractive near field (RNF). The surface stress was extrapolated in the first 2 micrometers to the values measured by a FSM-6000 LE. The center tension values at the middle of the sample were similar to measurements according to SCALP techniques. There is still some residual stress in a negligible amount after Step III annealing, which may be controlled by longer or higher temperature of the annealing process. Also, this residual stress can be further controlled and reduced by longer and higher temperature annealing times.

After Step III, new glass substrates with new glass compositions are formed which have a significant amount of lithium and a residual stress that is small and can be further controlled to be minimized towards zero, or engineered to be at a certain level as desired.

### Example A

### Comparative

A glass article was formed from the base glass “A” of Example 1 by exposing the base glass to a single ion exchange (SIOX) treatment comprising 80 wt % KNO₃/20 wt % NaNO₃ at 390° C. for 4 hours.

### Example 3

A glass article was formed from the glass substrate of Example 2C by exposing the substrate to the same SIOX treatment of Comparative Example A.

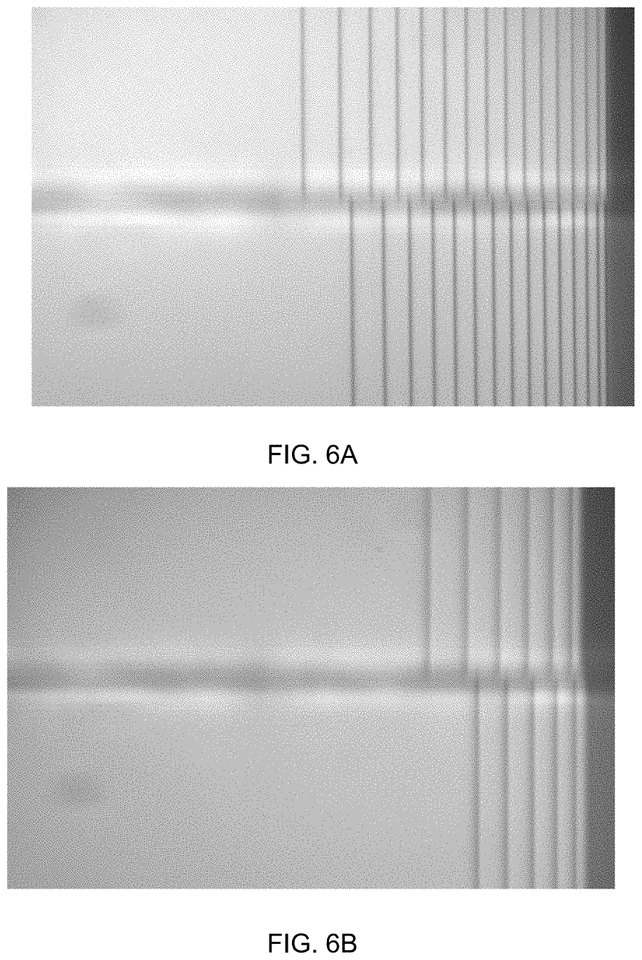

FIGS. 6A-6B show images of guided mode spectra fringes based on stress measurement by FSM-6000 LE. FIG. 6A shows the image of fringes for Comparative Example A. FIG. 6B shows the image of fringes for Example 3. The images of FIGS. 6A-6B demonstrate that a glass article formed from the inventive glass substrate is different from a glass article formed from the comparative base glass under the same IOX treatment. The initial fringes are different for the FIG. 6B due to the exchange of K for Na or Li in the underlying substrate, which creates a surface waveguide and creates a stress spike in the surface. The sodium/lithium exchange, which is faster and deeper in nature, cannot be visually inspected by these fringes of the FSM-6000 LE instrument.

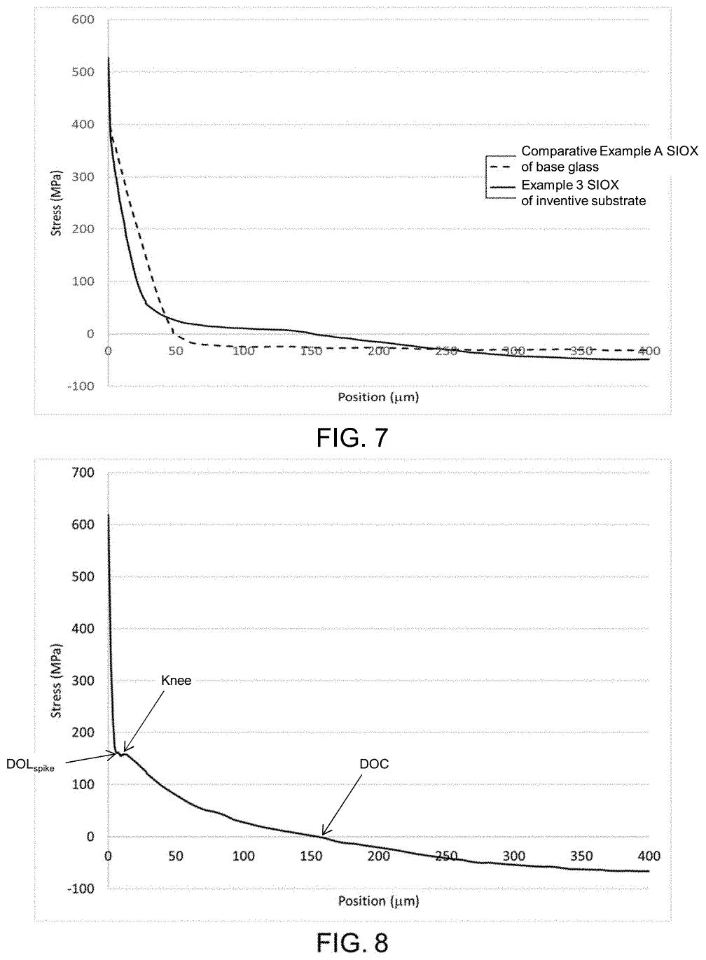

FIG. 7 provides a graph of stress (MPa) versus position (micrometers) for the glass articles of Example 3 and Comparative Example A. Measurement was made by refractive near field (RNF). The surface stress was extrapolated in the first 2 micrometers to the values measured by the FSM-6000 LE. The center tension values at the middle of the sample were similar to measurements according to SCALP techniques.

Because a large amount of lithium in the glass substrate of Example 2 used to make the glass-based article of Example 3 by ion-exchange permitted was present, a large amount of stress at depth was imparted. The lithium in the glass substrate originated from separate IOX according methods disclosed herein, not from the original base glass composition that came from bulk processing. The processes disclosed herein a flexible and independent of the manufacturing asset once a base glass is chosen.

### Example 4

A glass article was formed from the glass substrate of Example 2C. by exposing substrate to a double ion exchange (DIOX) treatment comprising a first step of 100 wt % NaNO₃ at 390° C. for 4 hours; and a second step of 90 wt % KNO₃/10 wt % NaNO₃ at 390° C. for 0.5 hours to form the glass-based article of Example 4.

In FIG. 8, a graph of stress (MPa) versus position (micrometers) for the glass-based article of Example 4 is provided. Measurement was made by refractive near field (RNF). The surface stress was extrapolated in the first 2 um to the values measured by the FSM-6000 LE. Thickness of the spike (DOLₛₚ) is approximately 6.5 micrometers with a surface stress (CS) of approximately 650 MPa (CS). The stress at the knee (CSₖₙₑₑ) that is the asymptotic point that connects the spike to the tail of the profile was ˜180 MPa. While the point where the stress crosses zero was at 155 micrometers, known as depth of compression (DOC). The stress at the center of the sample was ˜66 MPa being the center tension (CT).

As this example demonstrates, complex stress profiles can be targeted using the glass substrates prepared in accordance with the methods herein.

### Example 5

A series of glass substrates were formed in accordance with the general Steps I-III and the same base glass “A” of Example 1. Table 2 provides a summary of the process parameters and resulting Li₂O content of the glass substrate. For Step I and Step II, bath concentration, time, and temperature of the ion-exchange process used are listed. For Step III, hold time and hold temperature of the annealing step is listed. Step I and Step III were the same. In Step II, which introduced lithium inside the glass, variations in ion exchange duration were tested.

TABLE 2

| | | | | Li₂O at |
|---|---|---|---|---|
| | | | | 0 μm |
| Sample | Step I | Step II | Step III | (mol %) |
| 5A | 100 wt % KNO₃ - | 60 wt % KNO₃/40 wt % | 3 h - | ~6.60 |
| | 4 h - 390° C. | LiNO₃ - 8 h - 460° C. | 610° C. | |
| 5B | 100 wt % KNO₃ - | 60 wt % KNO₃/40 wt % | 3 h - | ~11.5 |
| | 4 h - 390° C. | LiNO₃ - 16 h-460° C. | 610° C. | |

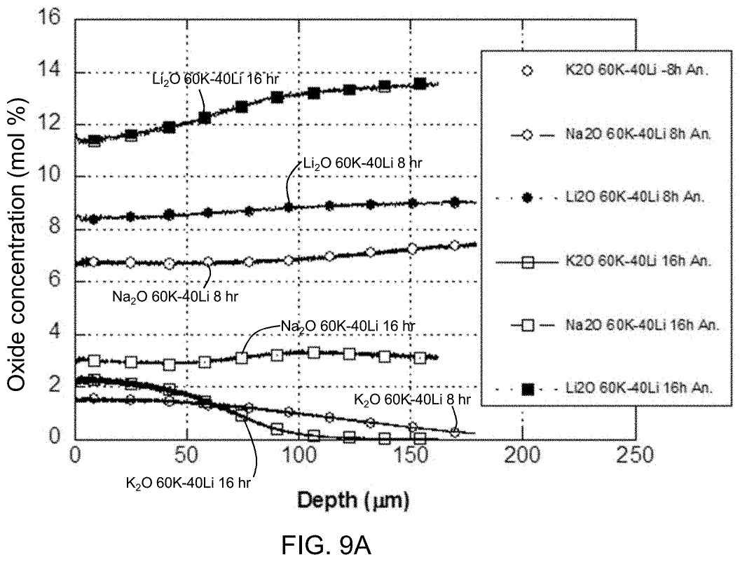

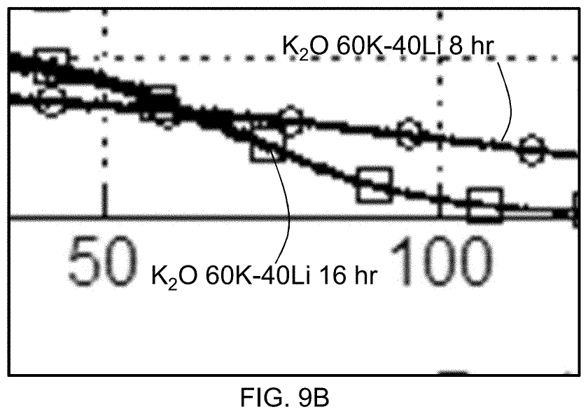

FIG. 9A provides a graph of oxide molar concentration of the glass substrate (after Step III) as a function of depth in the glass from a first surface (0 micrometers) was measured by Glow Discharge-Optical Emission Spectroscopy (GD-OES). Overall precision of the measurement was approximately 0.2 mol %. Here, for simplicity, only the amount of Li₂O detected in the surface is shown. For a longer duration during Step II (Sample 5.B), more Li content was introduced.

FIG. 9B shows an enlargement of the boxed area of FIG. 9A over the range of slightly less than 50 micrometers and slightly greater than 100 micrometers. This is an exemplary region of decreasing potassium concentration. Sample 5A (8 hours annealing) showed a random parabolic shape for the potassium concentration. The potassium profile of Sample 5A decreased from 1.38 mol % at 50 micrometers to 1.20 mol % at 75 micrometers to 0.97 mol % at 100 micrometers. Over the depth of 50 to 100 micrometers, the potassium decreased by 0.3% of its starting concentration. That is, the decrease from 1.38 mol % to 0.97 mol % is an absolute mol % difference of 0.41 mol %, which represents 0.3% of 1.38 mol %. Sample 5B (16 hours annealing) showed an s-shape for the potassium concentration. The potassium profile of Sample 5B decreased from 1.74 mol % at 50 micrometers to 0.87 mol % at 75 micrometers to 0.21 mol % at 100 micrometers. Over the depth of 50 to 100 micrometers, the potassium decreased by 88% of its starting concentration. That is, the decrease from 1.74 mol % to 0.21 mol % is an absolute mol % difference of 1.53 mol %, which represents 88% of 1.74 mol %.

### Example 6

A glass article formed by conducting the DIOX treatment of Example 4 on the glass substrate of Example 5A.

The lower annealing temperature (610° C.) of Example 5A during formation of the substrate as compared to Example 2C (630° C.) led to less surface warp in Example 6 as compared to Example 4 upon visual comparison of the articles.

### Example 7—Testing

Various base glasses, inventive glass substrates, and inventive glass-based articles were tested for drop performance. A controlled drop test included multiple drops of glass were performed using a phone-sized puck being dropped onto a 180 grit sand-paper (to simulate rough surfaces) or onto a 30 grit sand-paper. Drop tests were performed under ambient conditions (air, room temperature). The first drop was performed at a starting height of 20 cm, which represented the distance from the exposed surface of a cover glass to the top of a drop surface. If no cover glass failure occurred on the 180 grit sand-paper, the drop height was increased by 10 cm, and the puck dropped again. For samples that survived a drop from 220 cm onto the 180 grit sand-paper were then tested the same way against 30 grit sand-paper. The puck was sequentially dropped at 10 cm increments (e.g., 10 cm, then 20 cm, then 30 cm, etc.) until the cover glass failed.

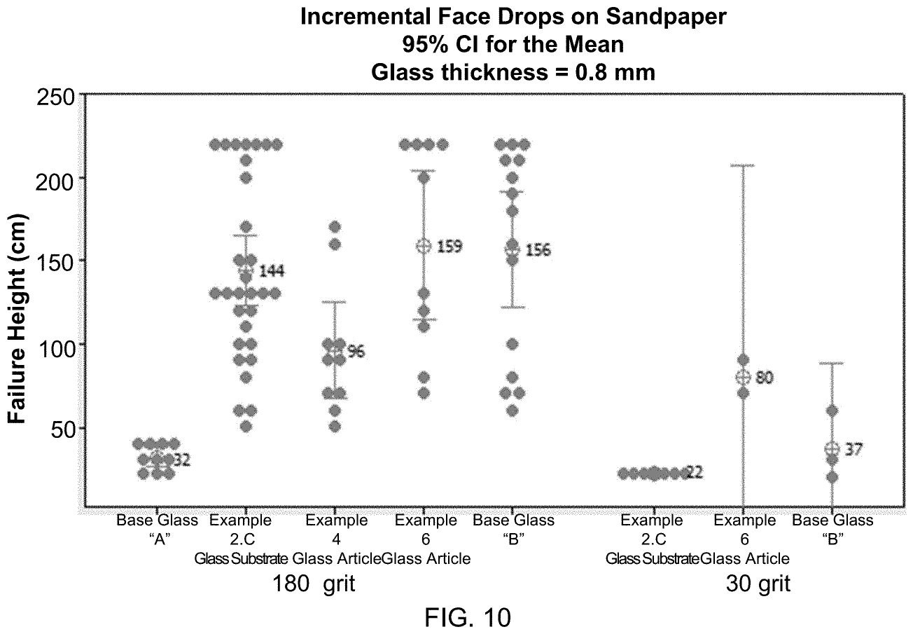

FIG. 10 is a graph of results of the controlled-drop process, where height where cover glass failure occurred is provided. Table 3 provides a summary of the base glasses, inventive glass substrates, and inventive glass articles and the corresponding drop performance.

TABLE 3

| | | Drop Performance |
|---|---|---|
| | | Avg. Failure height |
| Sample Tested | Characteristics | & grit |
| Base Glass A | Na₂O 16.51 mol % | 32 cm on 180 grit |
| Comparative | No Li or other alkali | |
| Subject to IOX | IOX | |
| | Step I: 38 wt % NaNO₃/62 wt % KNO₃ at | |
| | 450° C.- 7 h 15 min | |
| | Step II: 0.5 wt % NaNO₃/99.5 wt % KNO₃ | |
| | at 390° C. - 0 h 12 min | |
| Example 2C | Na₂O ~6.9 mol % | 144 cm on 180 grit |
| Glass substrate | Li₂O ~8.38 mol % | 22 cm on 30 grit |
| Subject to IOX | K₂O ~1.8 mol % | |
| | IOX | |
| | Step I: 49 wt % NaNO₃/51 wt % KNO₃ at | |
| | 460° C.- 14 h | |
| | Step II: 0.5 wt % NaNO₃/99.5 wt % KNO₃ | |
| | at 390° C. - 0 h 15 min | |
| Example 4 | DIOX of Example 2C (anneal 630° C.) | 96 on 180 grit |
| Glass Article | | |
| Example 6 | DIOX of Example 5A (anneal 610° C.) | 159 on 180 grit |
| Glass Article | | 80 on 30 grit |
| Base Glass B | Na₂O 10.81 mol % | 156 on 180 grit |
| Comparative | Li₂O 6.24 mol % | 37 on 30 grit |
| | Fusion drawn | |

For comparison, base glass A subject to IOX and base glass B were drop tested. Base glass A strengthened by IOX, which did not contain any Li₂O, failed at a height of 32 cm on 180 grit sand-paper. Base glass B, which contained 6.24 mol % Li₂O, averaged a failure height of 156 cm on 180 grit and 37 cm on 30 grit sand-paper. Inventive glass substrate Example 2C strengthened by IOX had better drop performance than base glass A strengthened by IOX (average failure height of 144 cm on 180 grit and 22 cm on 30 grit). Base glass B had only slightly better performance than glass substrate Example 2C strengthened by IOX. Glass articles Examples 4 and 6 outperformed base glass A strengthened by IOX, but Example 4 did not perform as well as base glass B or Examples 2C strengthened by IOX or Example 6. Example 6 had less warp than Example 4 which contributed to the better performance of Example 6 over Example 4.

Example 6 outperformed base glass B, which demonstrates that the inventive methods that include adding Li post-bulk processing to create new glass substrate compositions can achieve drop performance that is comparable or exceeds performance of some glass substrates directly from bulk processing.

### Example 8

A glass article formed by conducting the DIOX treatment of Example 4 on the glass substrate of Example 5B.

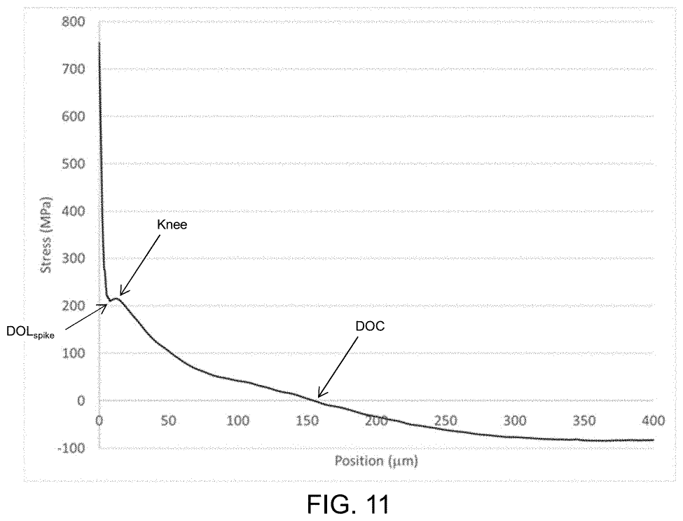

In FIG. 11, a graph of stress (MPa) versus position (micrometers) for the glass-based article of Example 8 is provided. Measurement was made by refractive near field (RNF). The surface stress was extrapolated in the first 2 um to the values measured by the FSM-6000 LE. Thickness of the spike (DOLₛₚ) is approximately 6.5 micrometers with a surface stress (CS) of approximately 750 MPa (CS). The stress at the knee (CSₖₙₑₑ) that is the asymptotic point that connects the spike to the tail of the profile was ˜210 MPa. While the point where the stress crosses zero was at 155 micrometers, known as depth of compression (DOC). The stress at the center of the sample was ˜75.3 MPa being the center tension (CT).

The glass article of Example 8 had a higher CSₖₙₑₑ as compared to Example 4, which reflects the difference in the Li content of the glass substrates, Example 5B (used in Example 8) contained ˜11.5 mol % at the surface, whereas Example 2C (used in Example 4) had ˜8.38 mol % at the surface.

While the foregoing is directed to various embodiments, other and further embodiments of the disclosure may be devised without departing from the basic scope thereof, and the scope thereof is determined by the claims that follow.

What is claimed is:

1. A method of manufacturing a glass substrate comprising:
obtaining a base glass having opposing first and second surfaces defining a thickness (t), and comprising a base composition containing an alkali metal oxide;
exposing the base glass to a first ion exchange treatment including ions of a first metal to form a protected base glass;
exposing the protected base glass to a second ion exchange treatment including the ions of the first metal and ions of a second metal to form a modified base glass; and
annealing the modified base glass to reduce stress and to obtain a distributed concentration profile of the alkali metal oxide, an oxide of the first metal, and an oxide of the second metal, thereby forming the glass substrate.

2. The method of claim 1, wherein the glass substrate comprises a residual stress of less than or equal to 35 MPa.

3. The method of claim 1, wherein the glass substrate comprises a residual stress of less than or equal to 5 MPa.

4. The method of claim 1, wherein after exposing the base glass to the first ion exchange treatment:
the alkali metal oxide is present in the protected base glass in a concentration that is zero at one or both of the first and second surfaces and varies along a portion of the substrate thickness (t) until the concentration reaches that of the alkali metal oxide in the base composition; and
the oxide of the first metal is present in the protected glass in a concentration that is non-zero at one or both of the first and second surfaces and varies along a portion of the substrate thickness (t) until tₚ where the concentration reaches that of any concentration of the oxide of the first metal in the base composition.

5. The method of claim 4, wherein after exposing the protected base glass to a second ion exchange treatment including the ions of the first metal and the ions of the second metal:
the alkali metal oxide is present in the modified base glass in a concentration that is zero at one or both of the first and second surfaces and varies along a portion of the substrate thickness (t) and the concentration along the portion of t is less than that of the alkali metal oxide in the base composition;
the oxide of the first metal is present in the modified glass in a concentration that is non-zero at one or both of the first and second surfaces and varies along a portion of the substrate thickness (t) until tₘ where the concentration reaches that of any concentration of the oxide of the first metal in the base composition; and
the oxide of the second metal is present in the modified glass in a concentration that is non-zero at one or both of the first and second surfaces and varies along a portion of the substrate thickness (t).

6. The method of claim 5, wherein tₘ is larger than the tₚ.

7. The method of claim 1, wherein the distributed concentration profile comprises:
the first alkali metal oxide in an average concentration that is less than its concentration in the base composition and that varies less than or equal to ±1 absolute mol % from a depth of greater than or equal to 0.18t to a center of the substrate;
the oxide of the first metal in an average concentration that is more than any of its concentration in the base composition and that varies less than or equal to ±1 absolute mol % from a depth of greater than or equal to 0.18t to a center of the substrate; and
the oxide of the second metal in an average concentration that is more than any of its concentration in the base composition and that varies less than or equal to ±1 absolute mol % from a depth of greater than or equal to 0.18t to a center of the substrate.

8. The method of claim 1, wherein the base glass is obtained from a bulk process selected from the group consisting of: float technique, fusion technique, rolling technique, slot draw technique, and crucible melting.

9. The method of claim 1, wherein the first and second metals are independently selected from the group consisting of: lithium (Li), sodium (Na), potassium (K), rubidium (Rb), cesium (Cs), francium (Fr), silver (Ag), gold (Au), copper (Cu), and combinations thereof.

10. The method of claim 1, wherein the first and second metals are alkali metals independently selected from the group consisting of: lithium (Li), sodium (Na), potassium (K), rubidium (Rb), cesium (Cs), and combinations thereof.

11. The method of claim 1, wherein the annealing is conducted at a hold temperature in the range of 300 to 800° C.

12. The method of claim 1, wherein the first and second ion exchange treatments independently comprise a bath temperature in the range of from greater than or equal to 300° C. to less than or equal to 1000° C.

13. The method of claim 1, wherein the ions of first and second metals are delivered by molten salts whose anions are independently selected from the group consisting of: nitrate, sulfate, carbonate, fluoride, chloride, borates, phosphates, and combinations thereof.

14. A method of manufacturing a glass substrate comprising:
obtaining a base glass having opposing first and second surfaces defining a substrate thickness (t), and comprising a base composition containing sodium oxide;
exposing the base glass that to a first ion exchange treatment including a molten potassium salt to form a protected base glass;
exposing the protected base glass to a second ion exchange treatment including the molten potassium salt and a molten lithium salt to form a modified base glass; and
annealing the modified base glass to reduce stress and to obtain a distributed concentration profile of the sodium oxide, potassium oxide, and lithium oxide, thereby forming the glass substrate.

15. The method of claim 14, wherein the glass substrate comprises a residual stress of less than or equal to 35 MPa.

16. The method of claim 14, wherein the distributed concentration profile comprises:
the sodium oxide in an average concentration that is less than its concentration in the base composition and that varies less than or equal to ±1 absolute mol % from a depth of greater than or equal to 0.18t to a center of the substrate;
the potassium oxide in an average concentration that is more than any of its concentration in the base composition and that varies less than or equal to ±1 absolute mol % from a depth of greater than or equal to 0.18t to a center of the substrate; and
the lithium oxide in an average concentration that is more than any of its concentration in the base composition and that varies less than or equal to ±1 absolute mol % from a depth of greater than or equal to 0.18t to a center of the substrate.

17. A glass-based article comprising:
silicon dioxide (SiO₂);
aluminum oxide (Al₂O₃); and
lithium oxide (Li₂O) in an amount of greater than 11 mol %; and
a fusion line.

18. The glass-based article claim 17, further comprising: a liquidus viscosity of less than or equal to 300 kP.

19. A glass-based article comprising:
opposing first and second surfaces defining a thickness (t);
silicon dioxide (SiO₂);
aluminum oxide (Al₂O₃);
sodium oxide (Na₂O);
lithium oxide (Li₂O); and
potassium oxide (K₂O),
wherein a potassium oxide concentration profile of the article comprises a region of decreasing potassium concentration located at a depth of greater than a spike depth of layer and less than or equal to a depth of compression.

20. The glass-based article of claim 19, wherein the potassium concentration over the region of decreasing potassium concentration decreases in an amount of less than or equal to 2%.

21. The glass-based article of claim 19, wherein the potassium concentration over the region of decreasing potassium concentration has an s-shape.

22. The glass-based article of claim 19, wherein the potassium concentration over the region of decreasing potassium concentration decreases in an amount of greater than or equal to 50%.
